(19) United States
(12) Patent Application Publication
(10) Pub. No.: US 2008/0287106 A1
(43) Pub. Date: Nov. 20, 2008

(54) Methods, systems, and computer program products for providing subscriber-controlled message service message delivery using a dynamic mailbox service

(75) Inventors: Patricia A. Baldwin, Raleigh, NC (US); Robert L. Wallace, Apex, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/906,745

(22) Filed: Oct. 3, 2007

Related U.S. Application Data
(60) Provisional application No. 60/930,305, filed on May 15, 2007.

(51) Int. Cl. H04Q 7/22

(52) U.S. Cl. 455/412.2; 455/466

(57) ABSTRACT

According to one aspect, the subject matter described herein comprises methods, systems, and computer program products for providing subscriber-controlled message service message delivery using a dynamic mailbox service. One method includes receiving a message service message destined for a subscriber and forwarding the message service message to a mailbox application server (MBAS) that provides dynamic mailbox service. At the MBAS, the dynamic mailbox service is provided, wherein providing the dynamic mailbox service includes allowing the subscriber to dynamically control delivery of the message service message from the MBAS to the subscriber.

### RELATED APPLICATIONS

This application claims the benefit of U.S. Provisional Patent Application Ser. No. 60/930,305, filed May 15, 2007; the disclosure of which is incorporated herein by reference in its entirety.

### TECHNICAL FIELD

The subject matter described herein relates to providing message service. More particularly, the subject matter described herein relates to methods, systems, and computer program products for providing subscriber-controlled message service message delivery using a dynamic mailbox service using existing mobile handset hardware and software.

### BACKGROUND

In many mobile communications networks, network operators charge a fee to both the sender and the receiver of messages. For subscribers belonging to messaging plans associated with one of these network operators, the rules determining which messages will be delivered to the subscribers' handsets and how these messages will be charged are therefore of great importance.

One conventional method for message delivery and billing includes the purchase of prepaid messaging credits by the mobile subscriber. In a so-called “prepaid messaging plan”, an amount is debited from the prepaid amount for each multimedia or text message received by a subscriber. Once the prepaid amount is exhausted, no further messages are received by the subscriber's handset.

Another conventional method for message delivery and billing includes delivering all messages to the recipient mobile subscriber and billing the subscriber at a first (lower) rate for an initial predetermined number of messages, and then charging a second (higher) rate for all subsequently received messages in excess of the initial number. For example, in a so-called “open-ended messaging plan” as described above, a subscriber may be charged 10 cents per received message for the first 50 received messages. Thereafter, the subscriber may be charged $1 per received message. Under such a plan, if a subscriber received 100 messages, he would be charged $55.

One problem associated with conventional prepaid messaging plans is that important and/or desired messages may not be received because the subscriber has exceeded his prepaid message amount. Therefore, while such a plan provides a predictable income stream for the carrier and a predictable cost to the subscriber, it lacks the flexibility to receive messages above the prepaid amount, such as in the case of an emergency.

One problem associated with conventional open-ended messaging plans is that the subscriber may be charged heavily for received messages which he has no ability to decline. Thus, while no important and/or desired messages are missed, an influx of unwanted messages may increase the subscriber's bill to an unreasonable and unpredictable amount.

Accordingly, a need exists for methods, systems, and computer program products for providing subscriber-controlled message service message delivery.

### SUMMARY

According to one aspect, the subject matter described herein comprises methods, systems, and computer program products for providing subscriber-controlled message service message delivery using a dynamic mailbox service hosted in the network and requiring no modifications to existing mobile handset equipment. One method includes receiving a message service message destined for a subscriber and forwarding the message service message to a mailbox application server (MBAS) that provides dynamic mailbox service. At the MBAS, the dynamic mailbox service is provided, wherein providing the dynamic mailbox service includes allowing the subscriber to dynamically control delivery of the message service message from the MBAS to the subscriber.

According to another aspect, the method includes sending a list of messages to the subscriber, where the list includes messages stored at the MBAS for the subscriber. The subscriber may make a selection of messages selected from the list of messages sent to the subscriber, and based on the received selection, the messages stored at the MBAS for the subscriber may be processed.

According to another aspect, the subject matter described herein includes a system for providing subscriber-controlled message service message delivery using a dynamic mailbox service. A mailbox application server (MBAS) provides the dynamic mailbox service and allows the subscriber to dynamically control delivery of the message service message from the MBAS to the subscriber. A mailbox screening function (MBSF) receives a message service message destined for the subscriber and forwards the message service message to the MBAS that provides the dynamic mailbox service.

### BRIEF DESCRIPTION OF THE DRAWINGS

The subject matter described herein will now be explained with reference to the accompanying drawings of which:

FIG. 1 is a diagram of an exemplary network illustrating immediate delivery of a text message according to conventional methods;

FIG. 2 is a call flow diagram illustrating immediate delivery of a text message according to conventional methods;

FIG. 3 is a diagram of an exemplary network illustrating delayed delivery of a text message according to conventional methods;

FIG. 4 is a call flow diagram illustrating delayed delivery of a text message according to conventional methods;

FIG. 5 is a diagram of an exemplary network for providing subscriber-controlled message service message delivery using a dynamic mailbox service, where the dynamic mailbox screening function is located at a signaling message routing node and the subscriber is a dynamic mailbox user according to an embodiment of the subject matter described herein;

FIG. 6 is a call flow diagram for providing subscriber-controlled inbound messaging using a dynamic mailbox service, where the dynamic mailbox screening function is located at a signaling message routing node and the subscriber is a dynamic mailbox user according to an embodiment of the subject matter described herein;

FIG. 7 is a diagram of an exemplary network for providing subscriber-controlled message service message delivery using a dynamic mailbox service, where the dynamic mailbox screening function is located at a signaling message routing node and the subscriber is not a dynamic mailbox user according to an embodiment of the subject matter described herein;

FIG. 8 is a call flow diagram for providing subscriber-controlled message service message delivery using a dynamic mailbox service, where the dynamic mailbox screening function is located at a signaling message routing node and the subscriber is not a dynamic mailbox user according to an embodiment of the subject matter described herein;

FIG. 9 is a call flow diagram of an exemplary network for providing subscriber-controlled message service message delivery using a dynamic mailbox service, where the dynamic mailbox screening function is located at a short message service center and the subscriber is a dynamic mailbox user according to an embodiment of the subject matter described herein;

FIG. 10 is a call flow diagram for providing subscriber-controlled message service message delivery using a dynamic mailbox service, where the dynamic mailbox screening function is located at a short message service center and the subscriber is a dynamic mailbox user according to an embodiment of the subject matter described herein;

FIG. 11 a diagram of an exemplary network for providing subscriber-controlled message service message delivery using a dynamic mailbox service, where the dynamic mailbox screening function is located at a short message service center and the subscriber is not a dynamic mailbox user according to an embodiment of the subject matter described herein;

FIG. 12 is a call flow diagram for providing subscriber-controlled message service message delivery using a dynamic mailbox service, where the dynamic mailbox screening function is located at a short message service center and the subscriber is not a dynamic mailbox user according to an embodiment of the subject matter described herein;

FIG. 13 is a diagram of an exemplary network for providing subscriber-controlled message service message delivery using a dynamic mailbox service, where the subscriber is an un-activated dynamic mailbox user according to an embodiment of the subject matter described herein;

FIG. 14 is a call flow diagram for providing subscriber-controlled message service message delivery using a dynamic mailbox service, where the subscriber is an un-activated dynamic mailbox user according to an embodiment of the subject matter described herein;

FIG. 15 is a diagram of an exemplary network for providing subscriber-controlled message service message delivery using a dynamic mailbox service, where the subscriber is an activated dynamic mailbox user and the sending subscriber is on a whitelist according to an embodiment of the subject matter described herein;

FIG. 16 is a call flow diagram for providing subscriber-controlled message service message delivery using a dynamic mailbox service, where the subscriber is an activated dynamic mailbox user and the sending subscriber is on a whitelist according to an embodiment of the subject matter described herein;

FIG. 17 is a diagram of an exemplary network for providing subscriber-controlled message service message delivery using a dynamic mailbox service, where the subscriber is an activated dynamic mailbox user and the sending subscriber is not on a whitelist according to an embodiment of the subject matter described herein;

FIG. 18 is a call flow diagram for providing subscriber-controlled message service message delivery using a dynamic mailbox service, where the subscriber is an activated dynamic mailbox user and the sending subscriber is not on a whitelist according to an embodiment of the subject matter described herein;

FIG. 19 is a diagram of an exemplary network for providing subscriber-controlled message service message delivery using a dynamic mailbox service, where a selection of messages is sent to the subscriber according to an embodiment of the subject matter described herein;

FIG. 20 is a call flow diagram for providing subscriber-controlled message service message delivery using a dynamic mailbox service, where a selection of messages is sent to the subscriber according to an embodiment of the subject matter described herein;

FIG. 21 is a diagram of an exemplary network for providing subscriber-controlled message service message delivery using a dynamic mailbox service, where a selection of messages is sent to the subscriber without utilizing a short message service center according to an embodiment of the subject matter described herein;

FIG. 22 is a call flow diagram for providing, subscriber-controlled message service message delivery using a dynamic mailbox service, where a selection of messages is sent to the subscriber without utilizing a short message service center according to an embodiment of the subject matter described herein;

FIG. 23 is a diagram of an exemplary network for providing subscriber-controlled message service message delivery using a dynamic mailbox service, where the subscriber selects the messages to be received according to an embodiment of the subject matter described herein;

FIG. 24 is a call flow diagram for providing subscriber-controlled message service message delivery using a dynamic mailbox service, where the subscriber selects the messages to be received according to an embodiment of the subject matter described herein;

FIG. 25 is a diagram of an exemplary network for providing subscriber-controlled message service message delivery using a dynamic mailbox service, where the dynamic mailbox processes a selection of messages from the subscriber according to an embodiment of the subject matter described herein;

FIG. 26 is a call flow diagram for providing subscriber-controlled message service message delivery using a dynamic mailbox service, where the dynamic mailbox processes a selection of messages from the subscriber according to an embodiment of the subject matter described herein;

FIG. 27 is a diagram of an exemplary network for providing subscriber-controlled message service message delivery using a dynamic mailbox service, where the subscriber initiates the selection of messages to be sent to the subscriber according to an embodiment of the subject matter described herein;

FIG. 28 is a call flow diagram for providing subscriber-controlled message service message delivery using a dynamic mailbox service, where the subscriber initiates the selection of messages to be sent to the subscriber according to an embodiment of the subject matter described herein;

FIG. 29 is a diagram of an exemplary network for providing subscriber-controlled message service message delivery using a dynamic mailbox service, where the subscriber initiates the selection of messages to be sent to the subscriber without utilizing a short message service center according to an embodiment of the subject matter described herein;

FIG. 30 is a call flow diagram for providing subscriber-controlled message service message delivery using a dynamic mailbox service, where the subscriber initiates the selection of messages to be sent to the subscriber without utilizing a short message service center according to an embodiment of the subject matter described herein;

FIG. 31 is a flow chart of a process for providing subscriber-controlled message service message delivery using a dynamic mailbox service according to an embodiment of the subject matter described herein; and

FIG. 32 is a diagram of an exemplary internal architecture of a network node for providing subscriber-controlled message service message delivery using a dynamic mailbox service according to an embodiment of the subject matter described herein.

### DETAILED DESCRIPTION

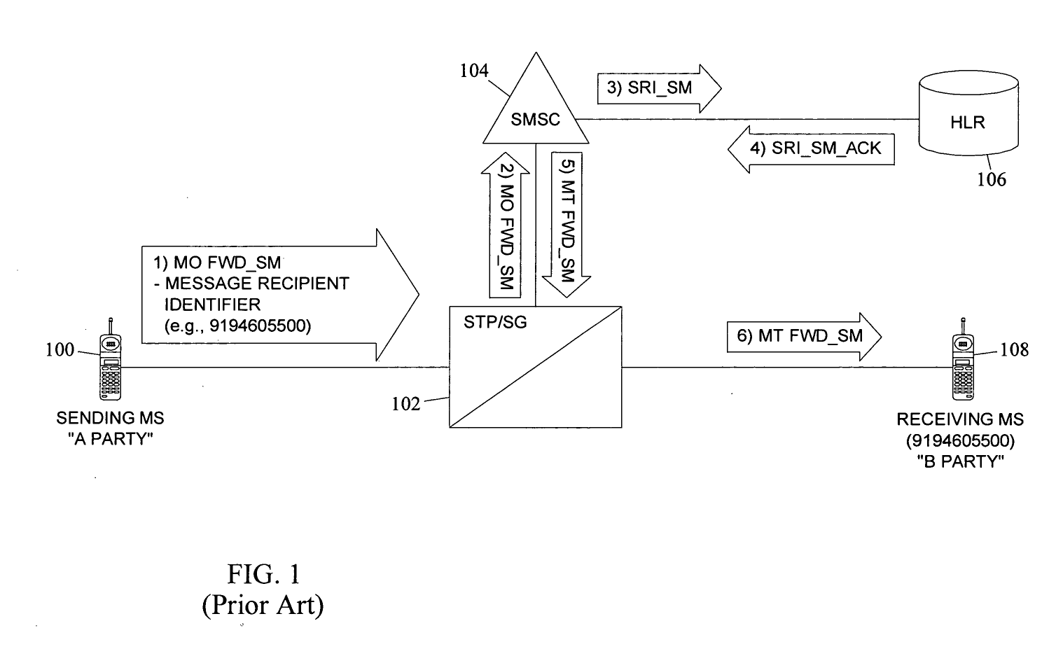

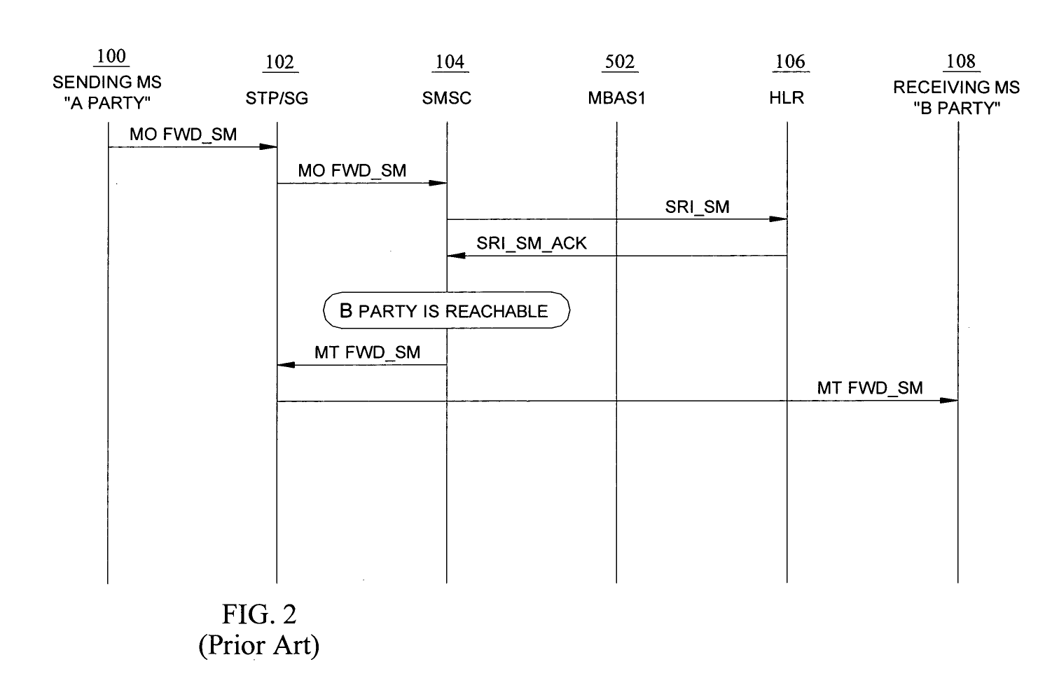

FIGS. 1 and 2 are a diagram and a call flow of an exemplary network illustrating immediate delivery of a text message according to conventional methods. The mobile communications network illustrated in FIG. 1 includes a sending mobile subscriber 100 for generating and sending messages, such as short message service (SMS) messages. Messages sent by sending mobile subscriber 100 are routed via signaling message routing node 102 to short message service center (SMSC) 104, which may include message storage for storing messages awaiting delivery in a store-and-forward message service message delivery scenario. Signaling message routing node 102 may include, for example, a signal transfer point (STP) or a signaling gateway (SG). Connected to SMSC 104 is a home location register (HLR) 106 for storing details of each mobile subscriber authorized to use a particular global system for mobile communications (GSM) network. For example, HLR 106 may store information associated with receiving mobile subscriber 108 connected to signaling message routing node 102. While exemplary components for a GSM network are shown in FIG. 1, it is appreciated that other mobile communications networks may be used for the delivery of text messages, such as a code division multiple access (CDMA) mobile communications network, general packet radio service (GPRS) network, enhanced data rates for GSM evolution (EDGE) network, universal mobile telecommunications system (UMTS) network, IP Short Message Peer-to-Peer (SMPP) network, or high speed packet access (HSPA) network. Additionally, the received message service messages can include multimedia message service (MMS) messages, instant messaging (IM) service messages, and session initiation protocol (SIP) messages. However, for purposes of illustration, SMS messages will be used in the figures described below.

In FIG. 1, sending mobile subscriber (MS) 100 (hereinafter referred to as the “A Party”) sends a text message, such as a mobile application part (MAP) MO_FWD_SM message intended for receiving mobile subscriber 108 (hereinafter referred to as the “B Party”) and routed by node 102 to SMSC 104. It is appreciated that the ‘A Party’ could also be a computer system (i.e. an application server) that generates SMS/MMS messages for delivery to the ‘B Party.’ However, for purposes of illustration, ‘A Party’ will be depicted as a mobile handset. In order to attempt delivery of the message to B party 108, SMSC 104 queries HLR 106 for the location of B Party 108. For example, SMSC 104 may generate and send a SRI_SM query to HLR 106, which may perform a lookup based on information included in the query, and generate and return a SRI_SM_ACK message to SMSC 104. SMSC 104 may then deliver a MT_FWD_SM message to B Party 108 via node 102. After delivery, SMSC 104 may generate appropriate billing information for the transaction.

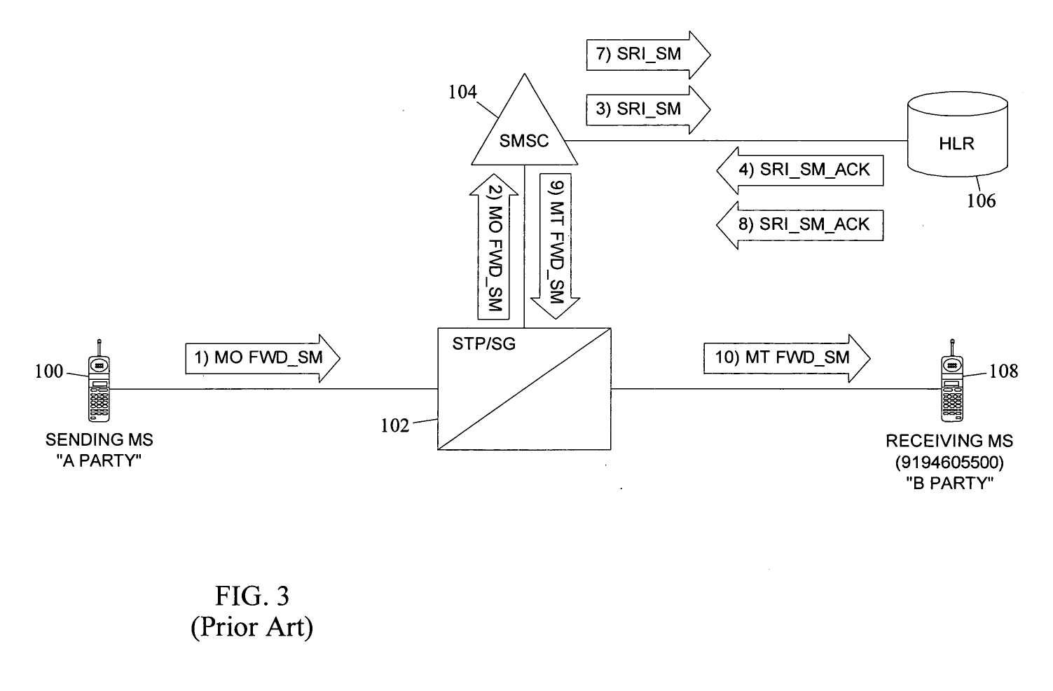

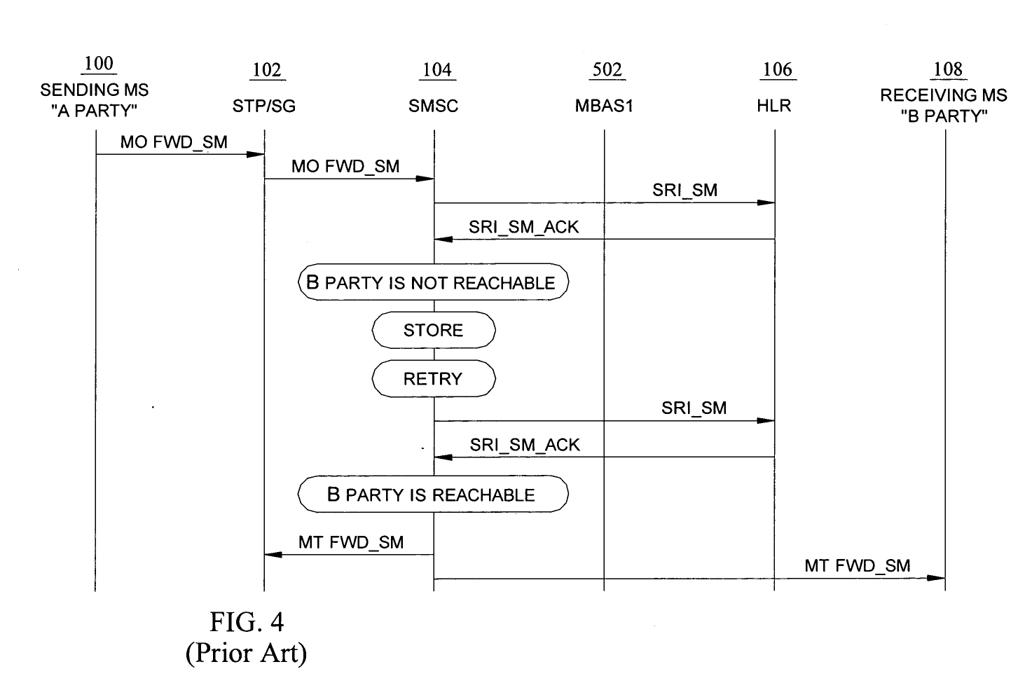

FIGS. 3 and 4 are a diagram and a call flow of an exemplary network illustrating delayed delivery of a text message according to conventional methods. In FIG. 3, a message sent by A Party 100 intended for B Party 108 is not delivered successfully on the first delivery attempt. Therefore, conventional store-and-forward logic is employed whereby the message is stored while further delivery attempts are made. For example, upon receiving MO_FWD_SM message, SMSC 104 queries HLR 106 in order to retrieve current information necessary to deliver the message to B Party 108, and attempts delivery. However, information returned in the SRI_SM_ACK indicates that delivery is not possible due to, for example, the temporary unavailability of B Party 108. Thus, SMSC 104 stores the message and after a predetermined time period has elapsed, initiates a second delivery attempt of the message. As described above, SMSC 104 may again query HLR 106 in order to deliver the message which, in the example illustrated in FIG. 3, succeeds on the second attempt. Again, billing information associated with the transaction may be generated upon delivery of the message to B Party 108. The processes described above for conventional message delivery in a mobile communications network illustrate both immediate delivery and delayed delivery of message service messages. Embodiments of the subject matter as described below may reference conventional message delivery methods, and it is appreciated that those conventional message delivery methods include those described above with reference to FIGS. 1-4.

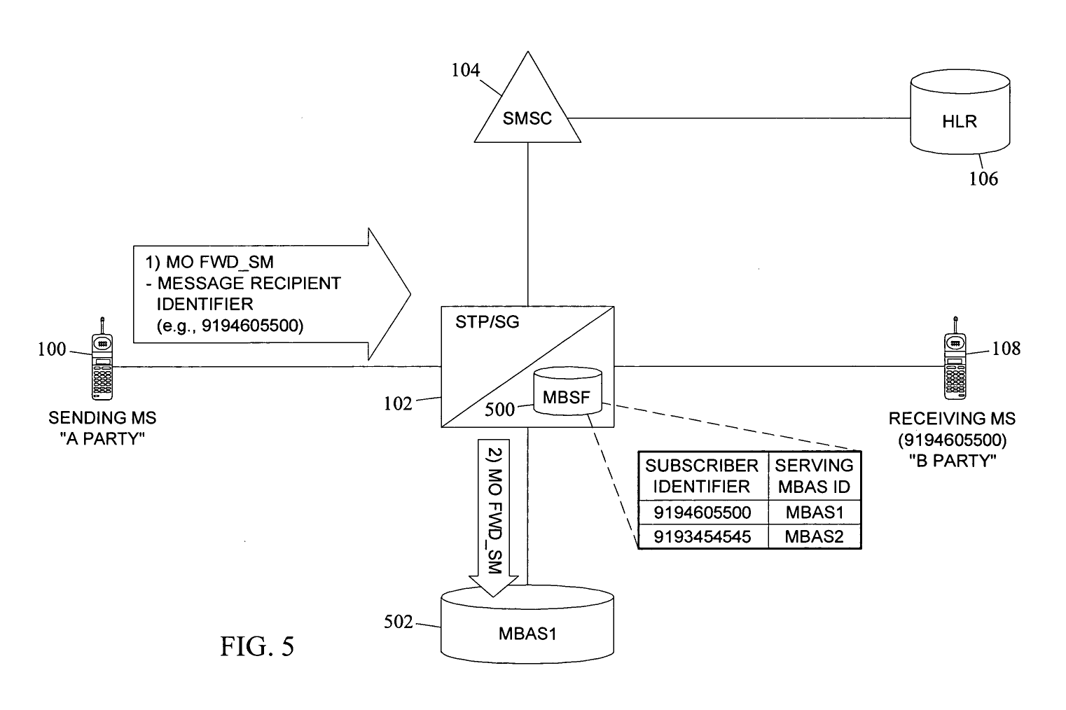

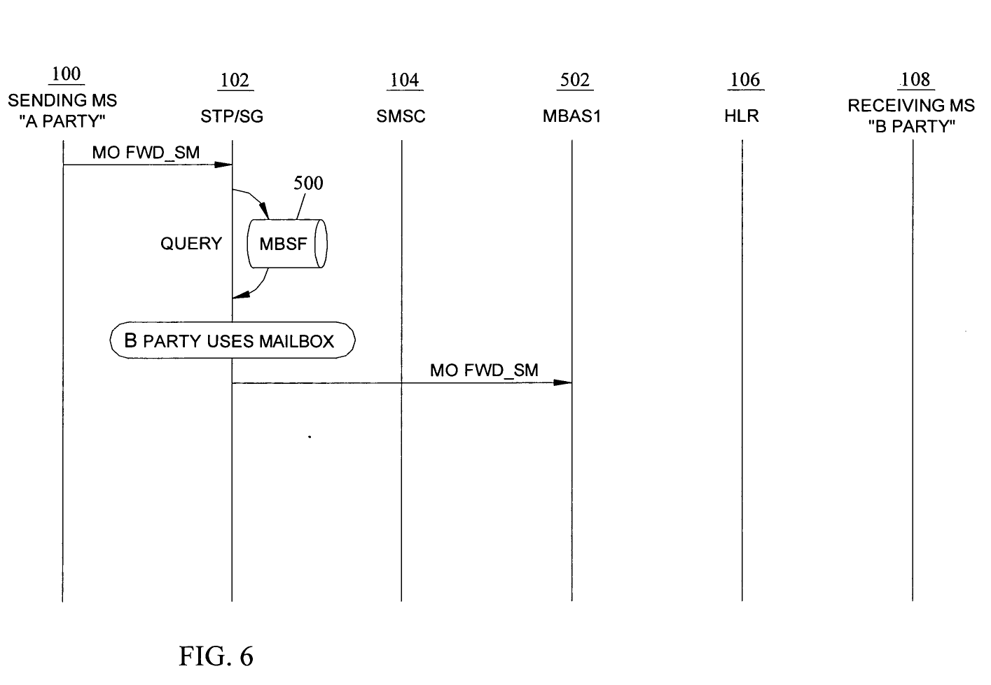

FIGS. 5 and 6 are a diagram and a call flow of an exemplary network for providing subscriber-controlled message service message delivery using a dynamic mailbox service, where the dynamic mailbox screening function is located at a signaling message routing node and the subscriber is a dynamic mailbox user according to an embodiment of the subject matter described herein. In the mobile communications network suitable for message service message delivery illustrated in FIG. 5, in addition to network components 100-108 as described above, routing node 102 may include mailbox screening function (MBSF) 500 for determining whether received messages are associated with a dynamic mailbox service. Additionally, node 102 may be connected to a dynamic mailbox application server (MBAS) 502 for providing dynamic subscriber-controlled message service message deliverys.

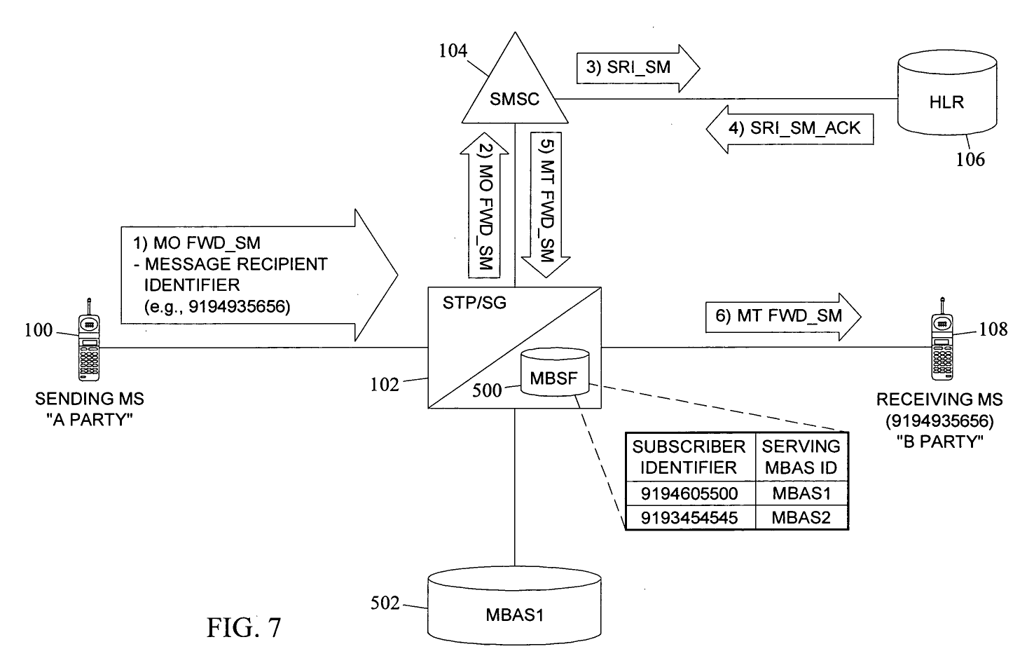

For example, if A Party 100 transmits a MO_FWD_SM message to routing node 102, MBSF 500 may perform a lookup to determine whether the subscriber 108 is associated with the dynamic mailbox service. In the example illustrated in FIG. 5, the subscriber identifier 9194695500 may be extracted from the received MO_FWD_SM message and used to locate a matching entry in a table. The result of the lookup indicates that B Party 108, as indicated by the subscriber identifier 9194695500, is associated with the dynamic mailbox service and the MBAS serving B Party 108 is MBAS1 502. It is appreciated that in addition to the network configuration shown in FIG. 5, additional MBASs may be employed in order to service a large number of subscribers. However, for purposes of this example and the examples described below with respect to FIGS. 7-30, it is assumed that if B Party 108 is associated with the dynamic mailbox service then B Party 108 is served by MBAS1 502. Upon determining that the message is intended for B Party 108 who is associated with MBAS 502, node 102 routes the MO_FWD_SM message to MBAS 502 for processing.

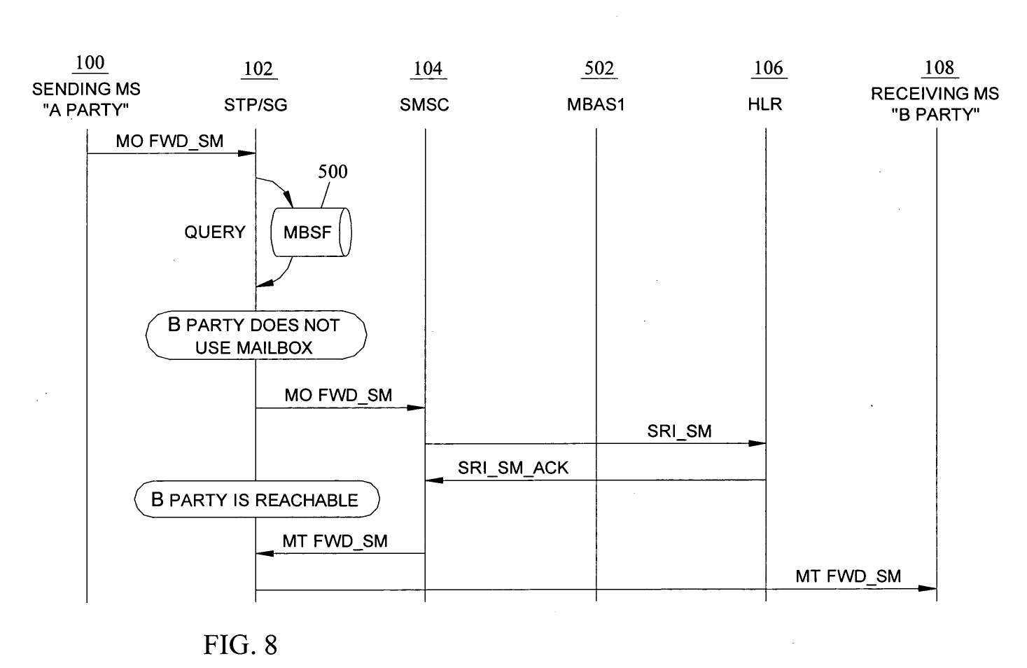

FIGS. 7 and 8 are a diagram and a call flow of an exemplary network for providing subscriber-controlled message service message delivery using a dynamic mailbox service, where the dynamic mailbox screening function is located at a signaling message routing node and the subscriber is not a dynamic mailbox user according to an embodiment of the subject matter described herein. In FIG. 7, upon receiving MO_FWD_SM message including subscriber identifier 9194935656 at signaling message routing node 102, MBSF 500 performs a lookup in order to determine whether the intended mobile subscriber recipient is associated with the dynamic mailbox service. In this example, MBSF 500 fails to locate a matching entry for the subscriber identifier 9194935656, indicating that the subscriber is not associated with the dynamic mailbox service. Accordingly, node 102 routes the message to SMSC 104 for conventional processing and delivery. It is appreciated that the exemplary messages illustrated in FIG. 7 are associated with the immediate conventional delivery described above.

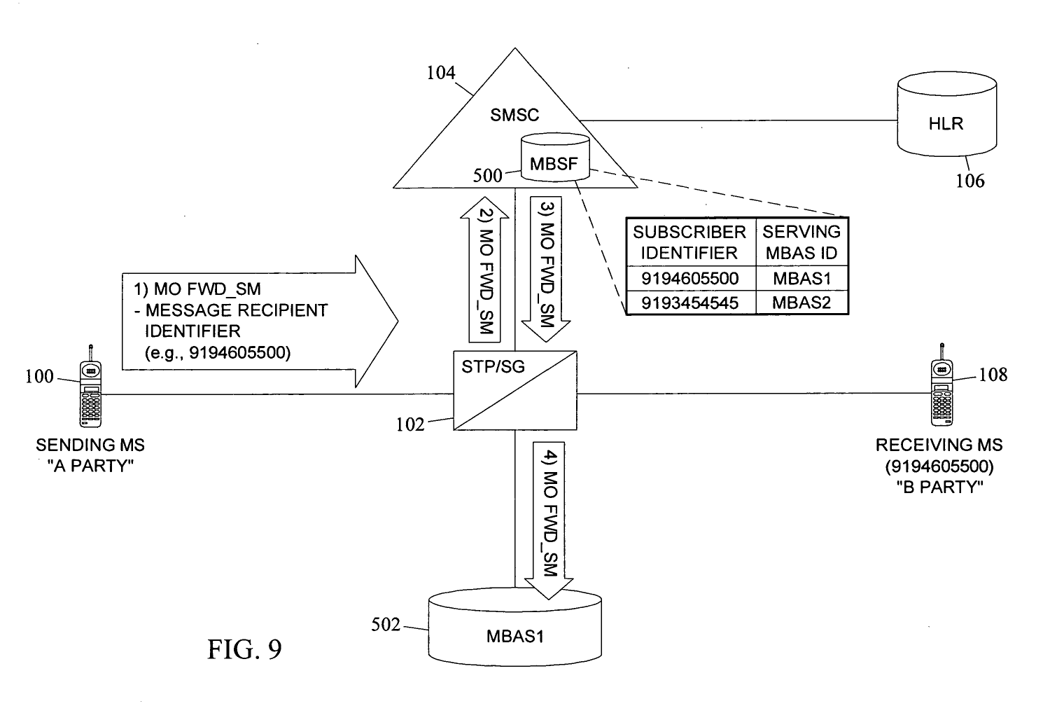

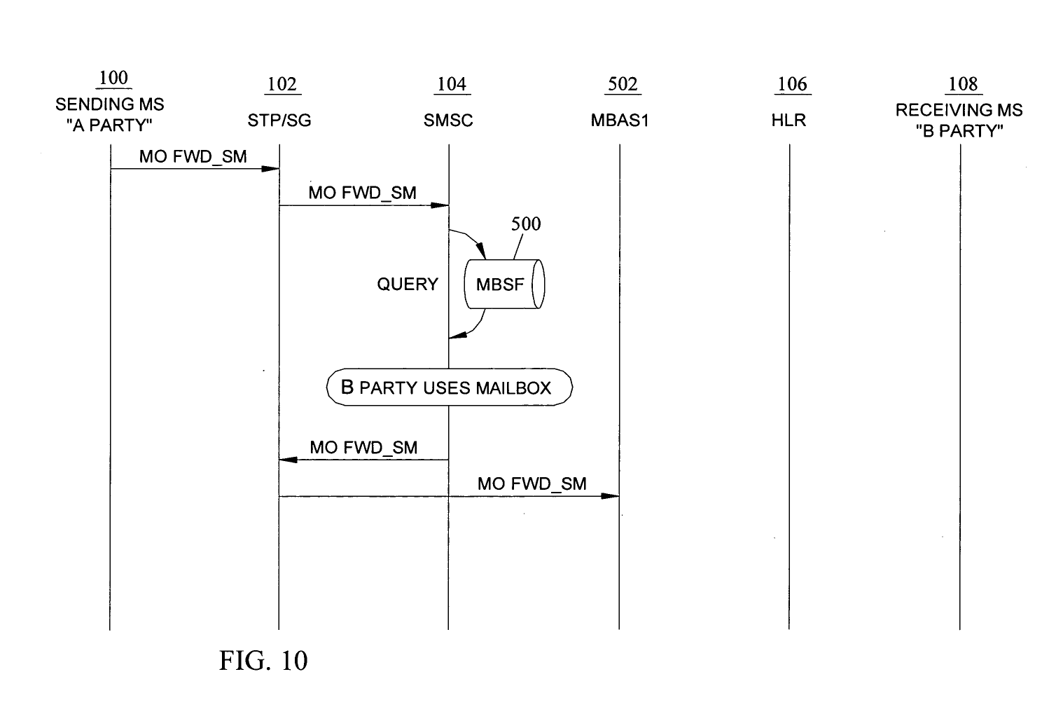

FIGS. 9 and 10 are a diagram and a call flow of an exemplary network for providing subscriber-controlled message service message delivery using a dynamic mailbox service, where the dynamic mailbox screening function is located at a short message service center and the subscriber is a dynamic mailbox user according to an embodiment of the subject matter described herein. In FIG. 9, MBSF 500 is located at SMSC 104 and B Party 108 is associated with subscriber identifier 9194605500. Thus, upon receiving MO_FWD_SM message from A Party 100, routing node 102 routes the message to SMSC 104, where MBSF 500 determines whether B Party 108 is associated with the dynamic mailbox service. Based on a lookup performed by MBSF 500 for an entry matching subscriber identifier 919460550, it is determined that B Party 108 is served by MBAS 502. Accordingly, SMSC 104 forwards the message to MBAS 502 for processing.

It is appreciated that in the example described above, if B Party 108 is a dynamic mailbox service user and the message originated from a network element that is not MBAS 502, then the message is routed to MBAS 502 instead of to B Party 108's mobile device. Moreover, the protocol for this message terminating may be GSM, CDMA, time division multiple access (TDMA), short message peer-to-peer protocol (SMPP), session initiation protocol (SIP), or any other suitable proprietary interface.

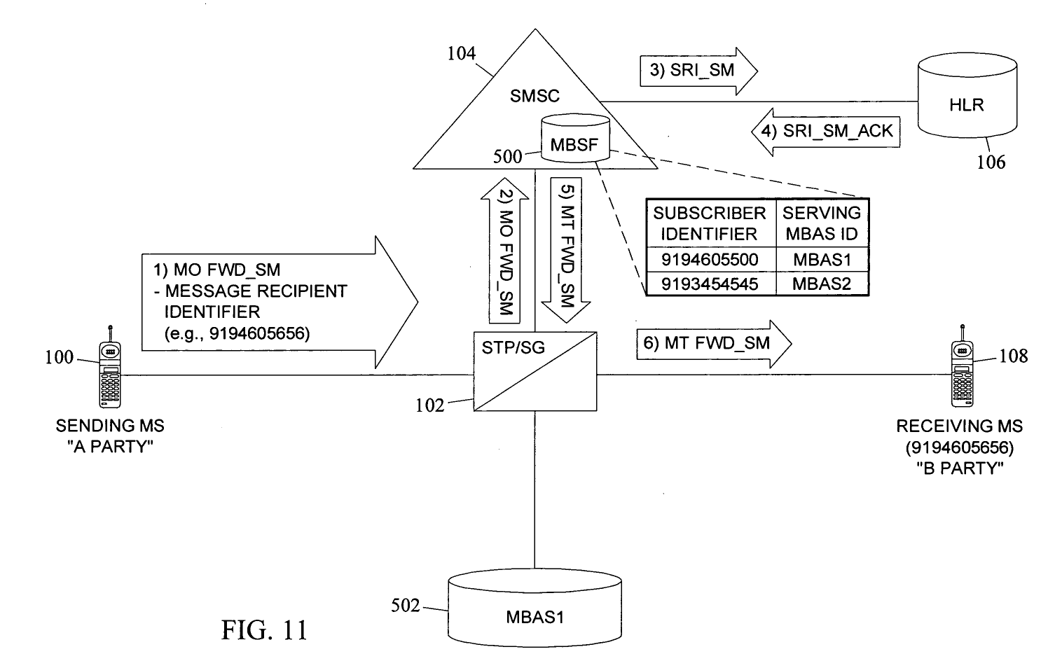

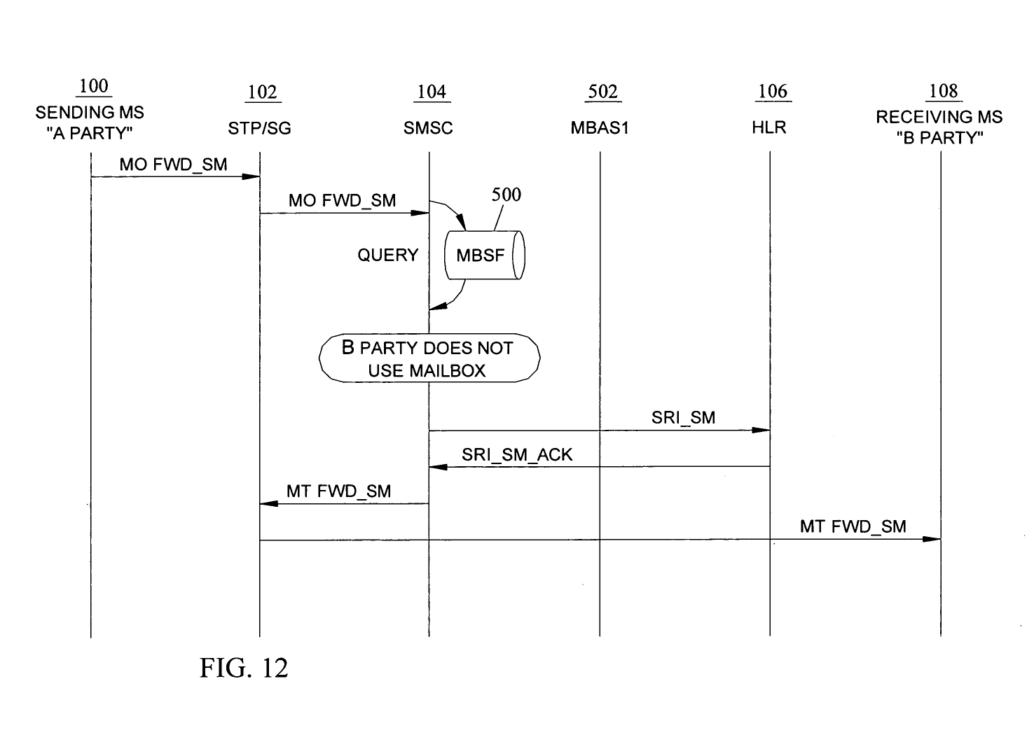

FIGS. 11 and 12 are a diagram and a call flow of an exemplary network for providing subscriber-controlled message service message delivery using a dynamic mailbox service, where the dynamic mailbox screening function is located at a short message service center and the subscriber is not a dynamic mailbox user according to an embodiment of the subject matter described herein. In FIG. 11, upon receiving MO_FWD_SM message including subscriber identifier 9194935656 at signaling message routing node 102, the message is routed to SMSC 104. At SMSC 104, a lookup is performed at MBSF 500 in order to determine whether the intended mobile subscriber recipient is associated with the dynamic mailbox service. In this example, MBSF 500 fails to locate a matching entry for the subscriber identifier 9194935656, indicating that the subscriber is not associated with the dynamic mailbox service. Accordingly, SMSC 104 may generate a SRI_SM query message and send it to HLR 106. SMSC 104 then receives an SRI_SM_ACK message enabling it to attempt delivery of the message to B Party 108. Accordingly, SMSC sends the MT_FWD_SM message to B Party 108 via routing node 102.

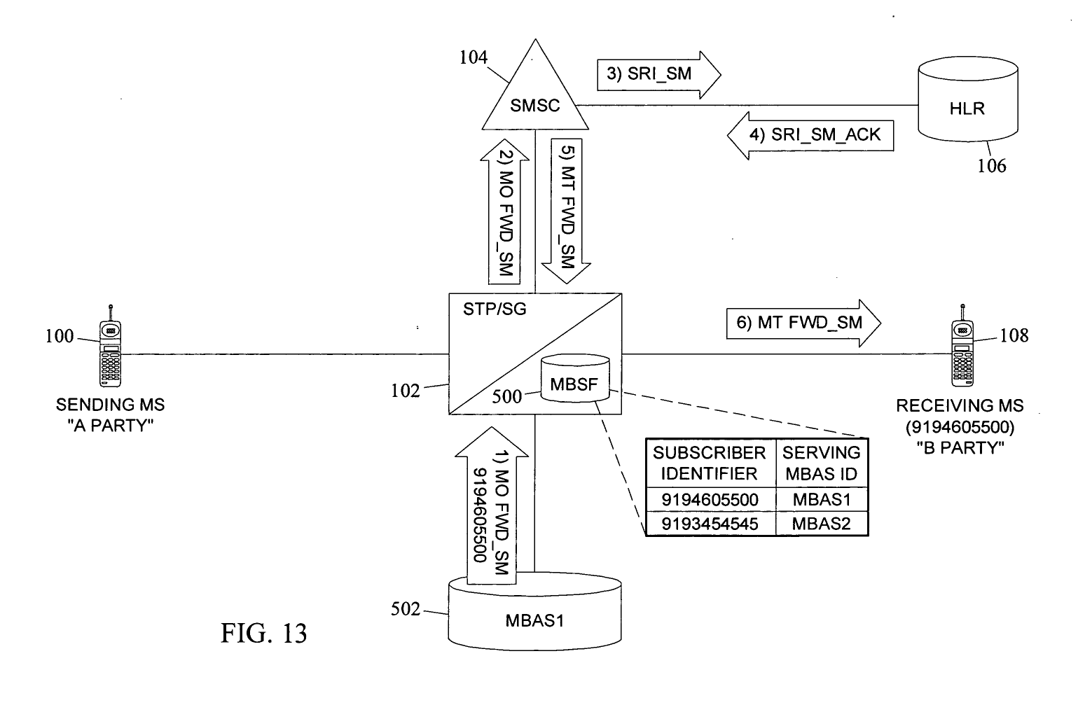

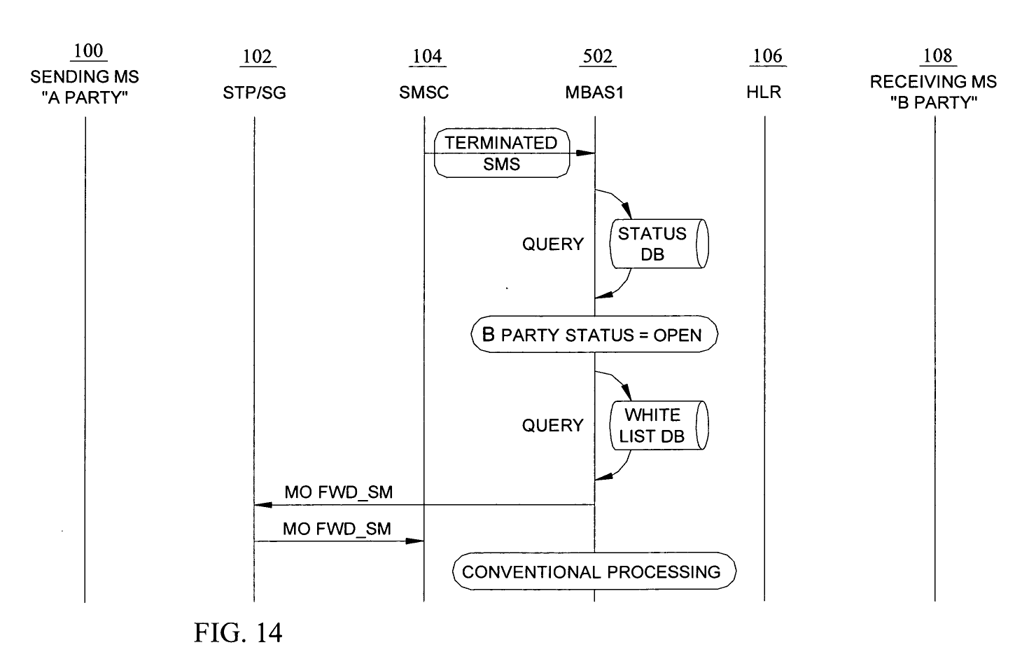

FIGS. 13 and 14 are a diagram and a call flow of an exemplary network for providing subscriber-controlled message service message delivery using a dynamic mailbox service, where the subscriber is an un-activated dynamic mailbox user according to an embodiment of the subject matter described herein. In FIGS. 13 and 14, it is assumed that B Party 108 is associated with the dynamic mailbox service and that, as described above with respect to FIGS. 5, 6, 9, and 10, a message intended for E Party 108 has been sent (also referred to as “terminated”) at MBAS 502. Thus, these previous messages are not shown in FIG. 13 for clarity of illustration.

After the message is terminated at MBAS 502, MBAS 502 queries a status database that may be co-located with MBAS 502 to determine whether B Party 108 has activated the dynamic mailbox service. In this example, the result of the query indicates that B Party 108 has not activated the dynamic mailbox service (i.e. status=open) and therefore desires for all messages to be delivered immediately. Accordingly, MBAS 502 submits the message to SMSC 104 for conventional delivery to B Party 108, and B Party 108 is billed.

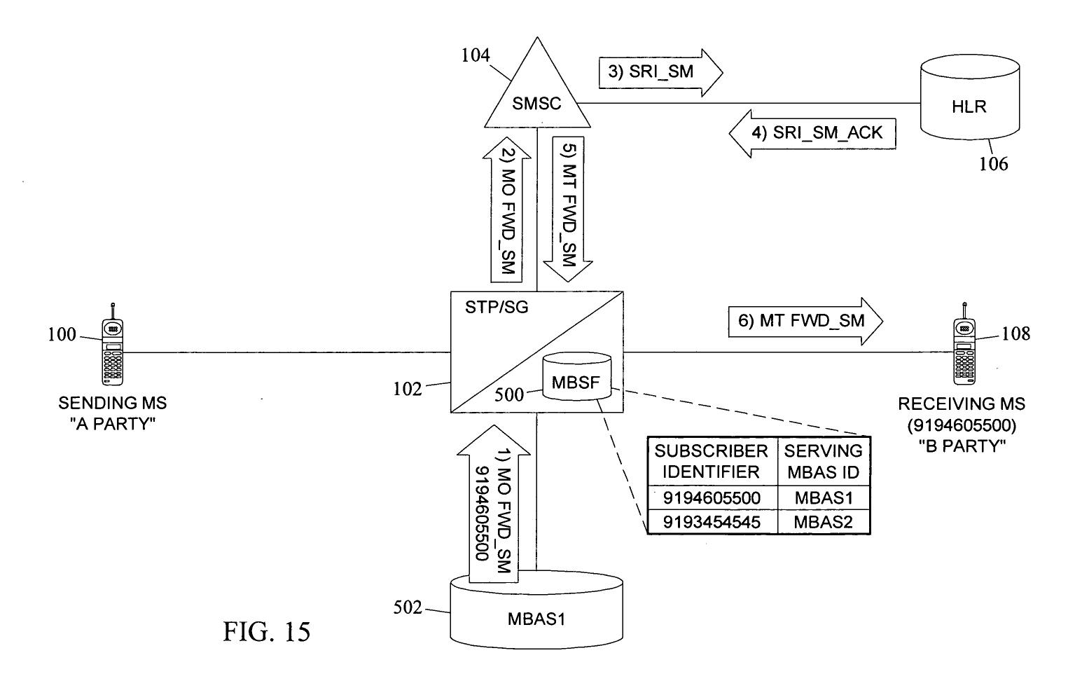

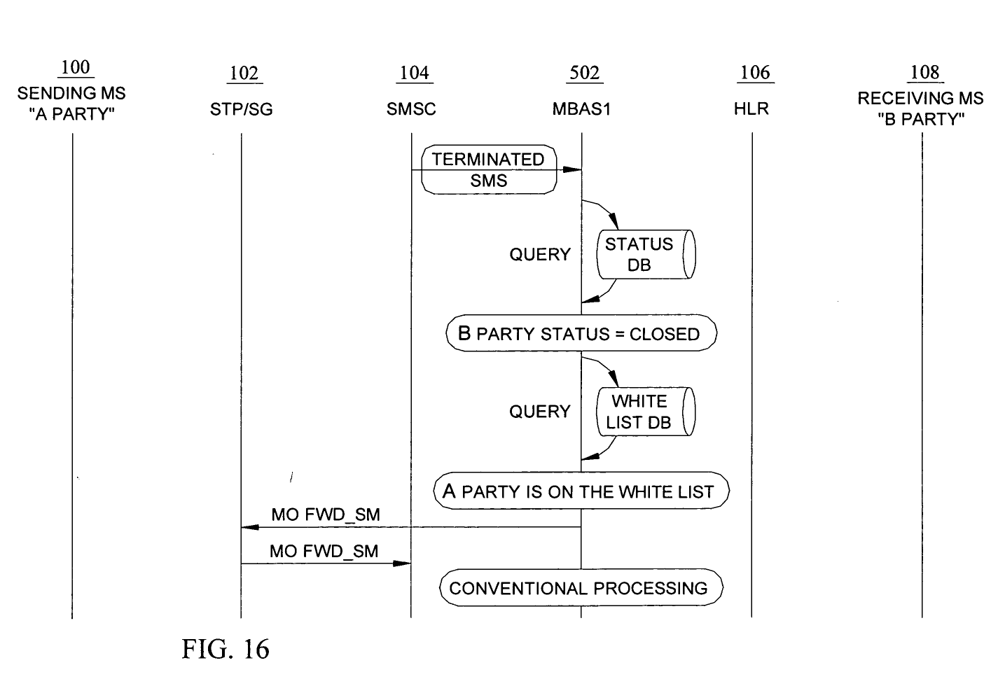

FIGS. 15 and 16 are a diagram and a call flow of an exemplary network for providing subscriber-controlled inbound messaging using a dynamic mailbox service, where the subscriber is an activated dynamic mailbox user and the sending subscriber is on a whitelist according to an embodiment of the subject matter described herein. In the example scenario illustrated in FIGS. 15 and 16, MBAS 502 queries its status database to determine whether B Party 108 has activated the dynamic mailbox service. The result of the query indicates that B Party 108 has activated the dynamic mailbox service (i.e. status=closed) and therefore immediate delivery of the message is not desired.

Therefore, a next lookup is performed by MBAS 502 to determine whether A Party 100 is on a pre-approved list of mobile subscribers allowed to send messages to be received by B Party 108. This list is hereinafter referred to as a “whitelist,” as it defines those mobile subscribers explicitly allowed to send messages to the subscriber when the subscriber status=“closed.” A corollary list may include a so-called “blacklist” which defines mobile subscribers explicitly denied from sending messages to the subscriber. In FIG. 16, the result of the whitelist lookup performed by MBAS 502 indicates that A Party 100 is allowed to send the message to B Party 108. Accordingly, the message is submitted to SMSC 104 for conventional delivery to B Party 108 and associated billing information may be generated. It is appreciated that SMSC 104 recognizes that the message is coming from MBAS 502 and therefore proceeds to deliver the message to B Party 108 using conventional methods including generating billing information if applicable.

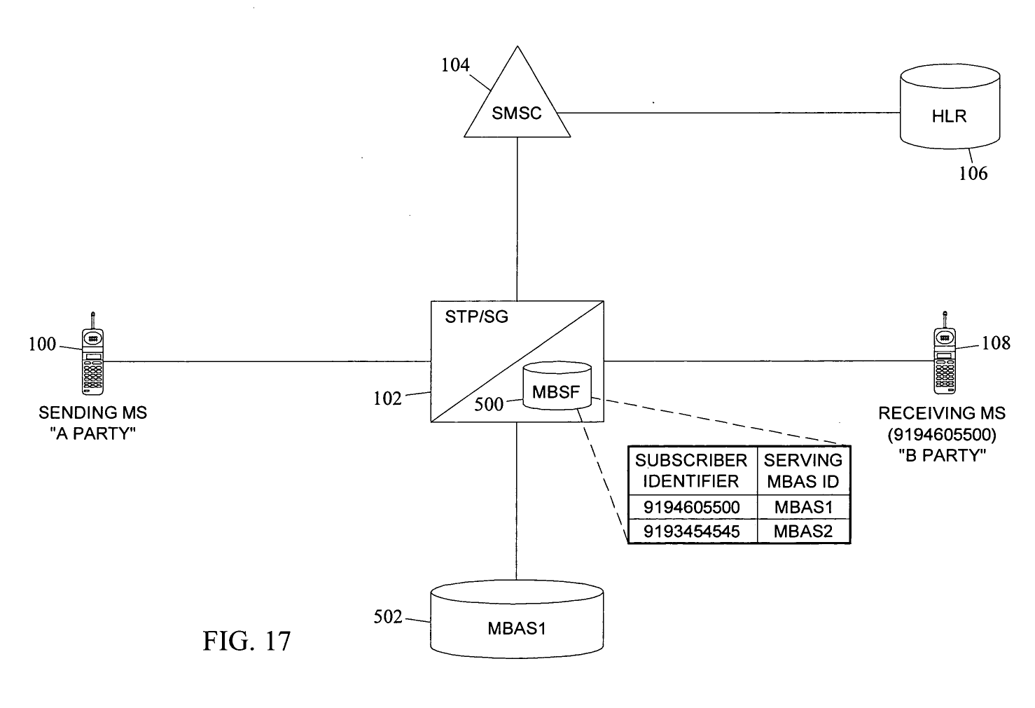

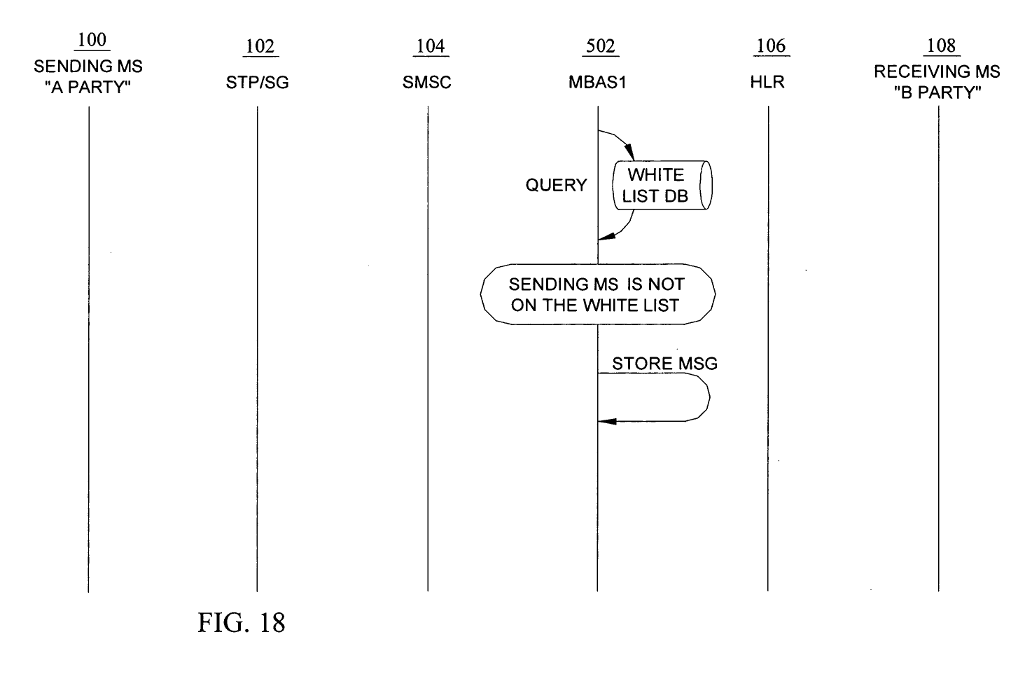

FIGS. 17 and 18 are a diagram and a call flow of an exemplary network for providing subscriber-controlled message service message delivery using a dynamic mailbox service, where the subscriber is an activated dynamic mailbox user and the sending subscriber is not on a whitelist according to an embodiment of the subject matter described herein. In the scenario illustrated in FIG. 18, MBAS 502 performs a lookup in the whitelist to determine whether A Party 100 is allowed to send messages to B Party 108. Because the result of the lookup indicates that A Party 100 is not on the whitelist, the message is not delivered and MBAS 502 stores the message. It is appreciated that in this scenario, MBAS 502 may be responsible for managing messages stored as a result the dynamic mailbox service described herein.

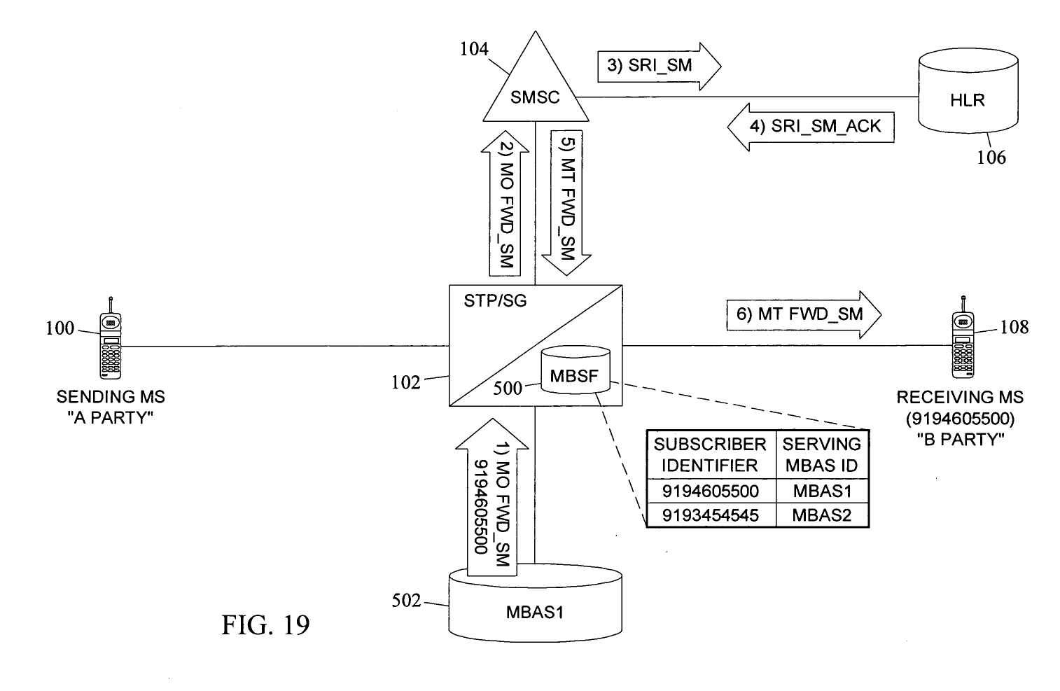

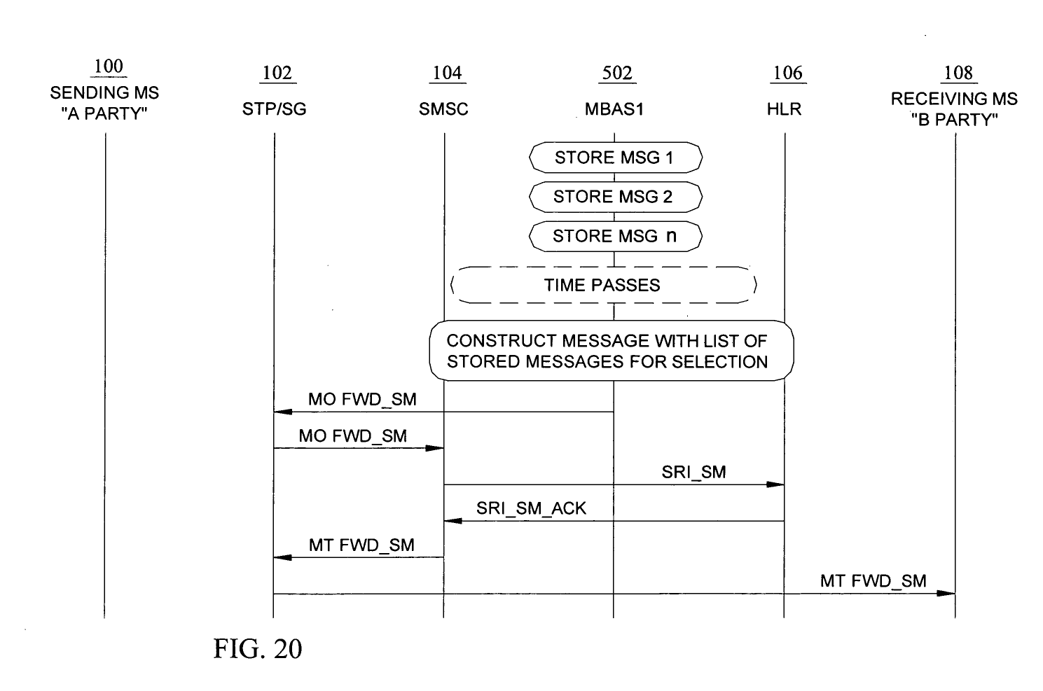

FIGS. 19 and 20 are a diagram and a call flow of an exemplary network for providing subscriber-controlled message service message delivery using a dynamic mailbox service, where a selection of messages is sent to the subscriber according to an embodiment of the subject matter described herein. Periodically, MBAS 502 sends a message to B Party 108 containing a list of messages currently stored in the dynamic mailbox. Each message may be identified, for example, by the sending party number. For example, after storing messages 1 through n at SMSC 104, after some predetermined period of time elapses, MBAS 502 constructs a multimedia or text message with a list of messages intended for delivery to B Party 108 and sends the MO_FWD_SM or SMPP message to SMSC 104. Upon receiving the message, SMSC 104 queries HLR 106 to determine information necessary for delivering the message to B Party 108. The information received from HLR 106 may be used to formulate a MT_FWD_SM message that is delivered to B Party 108 via node 102. It is appreciated that if B Party 108 is not available to receive the multimedia or text message, the notification message should not be subject to conventional store-and-forward logic but should instead be discarded. Alternatively, SMSC 104 may be configured to send a negative delivery receipt to MBAS 502 if so requested in the message submission. Additionally, MBAS 502 may be configured to manage the time interval between mailbox notifications based on internal configuration settings and/or user-configurable parameters. The content and format of the notification message may also be configurable based on the network operator's needs.

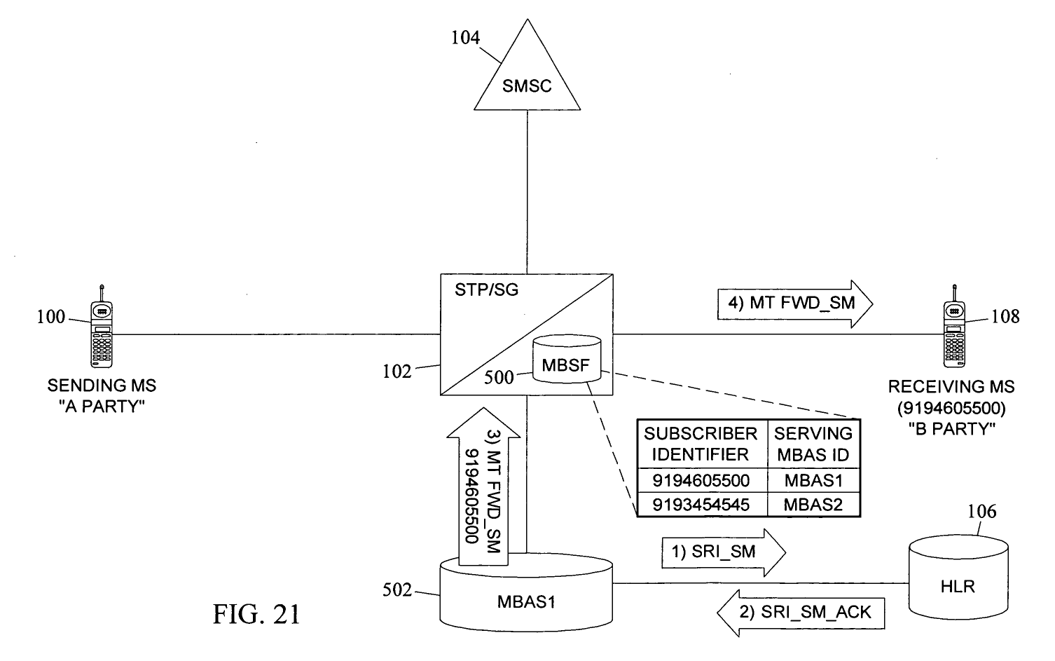

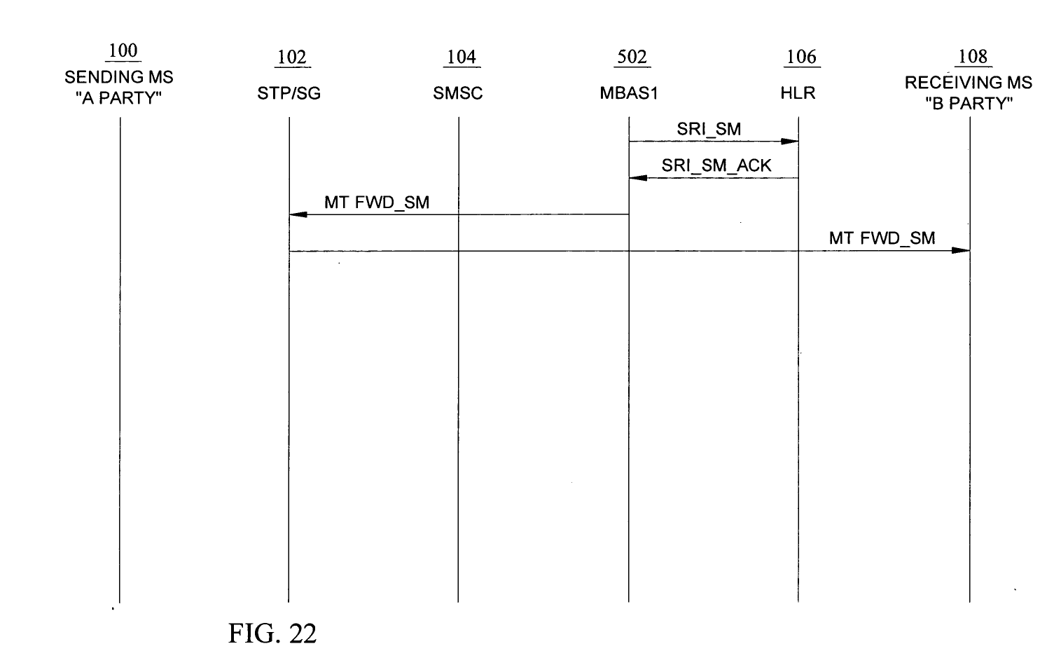

FIGS. 21 and 22 are a diagram and a call flow of an exemplary network for providing subscriber-controlled message service message delivery using a dynamic mailbox service, where a selection of messages is sent to the subscriber without utilizing a short message service center according to an embodiment of the subject matter described herein. In another example of periodically “pushing” a list of stored messages associated with a subscriber to the subscriber for selection, in FIG. 21 HLR 106 is connected to MBAS 502 such that no messages are sent or received by SMSC 104 in order to push the list of messages to B Party 108. This has the advantage to network operators of being able to shield existing SMSCs from additional traffic associated with the implementation of the subject matter described herein.

For example, in FIG. 21, MBAS 502 may begin the process of pushing a list of stored messages associated with B Party 108 to B Party 108 by querying HLR 106 for current location information by exchanging SRI_SM and SRI_SM Ack messages. As described in previous examples above, this information may be used to formulate a MT_FWD_SM message containing the list of stored messages, which is delivered to B Party 108 via node 102. As can be seen from differences between FIGS. 19 and 21, by connecting HLR 106 to MBAS 502 and shielding SMSC 104, the message list message is delivered to B Party 108 in two fewer messages, thereby advantageously reducing the message load in the communications network.

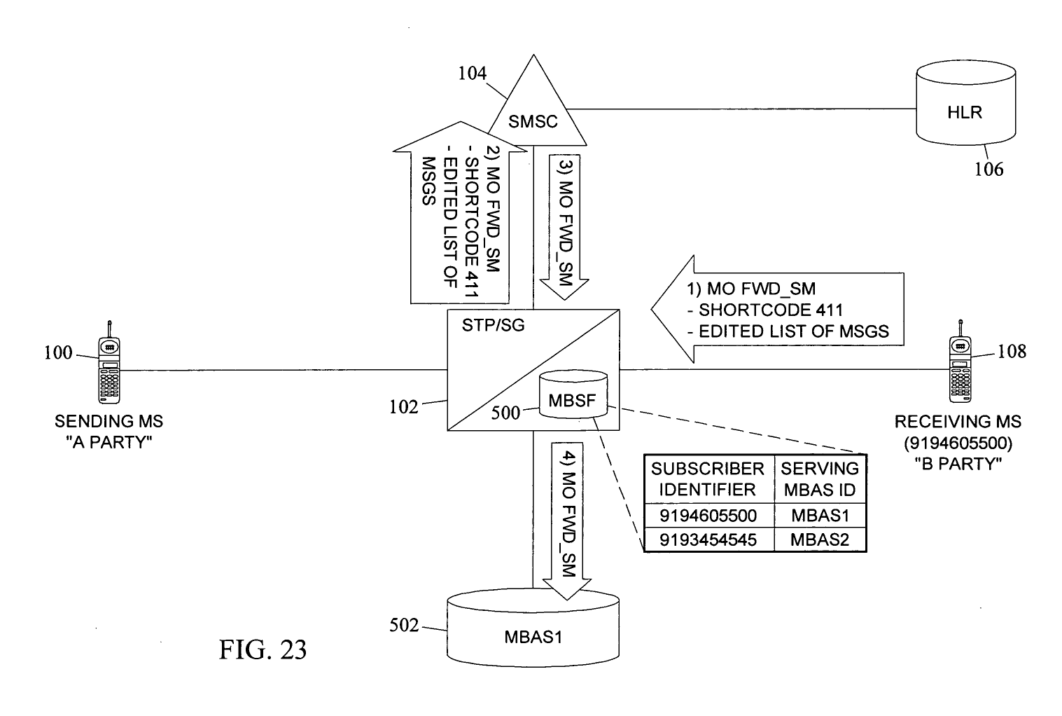

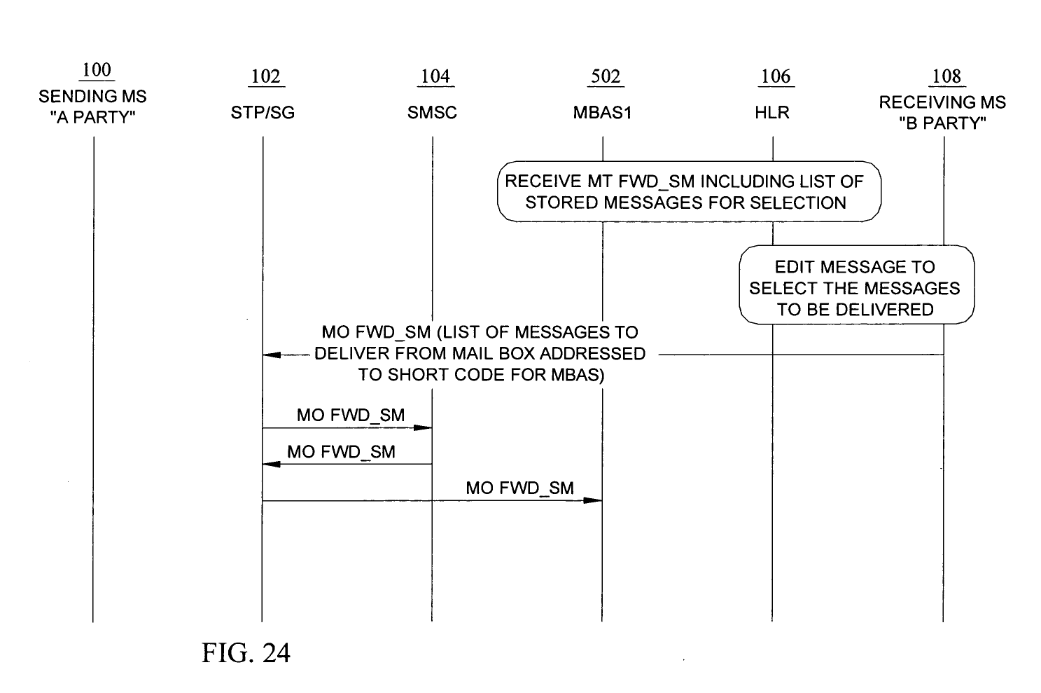

FIGS. 23 and 24 are a diagram and a call flow of an exemplary network for providing subscriber-controlled message service message delivery using a dynamic mailbox service, where the subscriber selects the messages to be received according to an embodiment of the subject matter described herein. After B Party 108 receives the message containing a list of messages stored by MBAS 502 described above, B Party 108 may select the messages he wishes to receive (and be billed for) based on the list presented in the list message. In FIG. 23, B Party 108 selects the messages he wishes to receive and returns an MO_FWD_SM message to SMSC 104 including a short code interpretable by SMSC 104 indicating that the message is to be routed to MBAS 502. Thus, upon receiving the MO_FWD_SM message sent by B Party 108, SMSC 104 interprets the included short code and routes the message to MBAS 502 for processing.

It is appreciated that a variety of methods may be used to edit the list of available messages contained in the message received by B Party 108 for controlling delivery of selected messages. In one embodiment, B Party 108 may delete the message indicators for messages that should not be delivered and may leave untouched the message indicators associated with messages B Party 108 wishes to receive. In another embodiment, B Party 108 may insert a special character, such as an asterisk, as a prefix or suffix to selected message indicators for distinguishing between messages to be delivered and messages to be blocked.

In another embodiment, a first designated character may be prepended or appended to a first set of message indicators and a second designated character may be prepended or appended to a second set of message indicators, where the first and second designated characters are different and indicate different desired treatment of the first and second sets of messages.

In another embodiment, two separate short codes may be used in one or more messages sent by B Party 108, where a first short code may indicate that the messages listed in the message are to be accepted (i.e. delivered) and a second short code may indicate that the messages listed in the message are to be rejected (i.e. deleted). A short code is a special digit sequence (typically 5 or 6 digits in North America) that is not a real dialed telephone number but may be used to route text messages to an application server instead of to a mobile client device. In this method, B Party 108 is not required to compose any special text in the message. For example, B Party 108 may generate and send a first text message (including any amount of text or none) to short code 2345 in order to turn on the dynamic mailbox feature. Alternately, B Party 108 may generate and send a second text message to short code 8765 in order to turn off the dynamic mailbox feature.

Similarly, mobile subscribers associated with the dynamic mailbox service may also turn on or off the dynamic mailbox feature included in the dynamic mailbox service at any time for any reason through communication of messages via their mobile handset. For example, B Party 108 may generate and send a first text message including the text string “MAILBOX ON” to short code 2345 in order to turn on the dynamic mailbox feature. Alternately, B Party 108 may generate and send a second text message to short code 8765 including the text string “MAILBOX OFF” in order to turn off the dynamic mailbox feature. It is appreciated that B Party 108 may also compose text messages containing different text strings, or no text at all, and send the message to a specified short code in order to turn on or off the dynamic mailbox feature without departing from the scope of the subject matter described herein. When SMSC 104 routes the message to MBAS 502 based on the short code, MBAS 502 may parse any text included in the message and act accordingly (i.e. by either turning on or turning off the dynamic mailbox feature based on the text string included in the message).

In addition to the embodiments described above, it is appreciated that other methods for message selection may be implemented without departing from the scope of the subject matter herein. It is further appreciated that SMSC 104 may route the message generated by B Party 108 including a short code to MBAS 502 using any protocol supported by MBAS 502. An advantage of the method described above is that it may use the message forwarding and message editing features available on the mobile subscriber's mobile handset device and therefore does not require any additional handset client functionality.

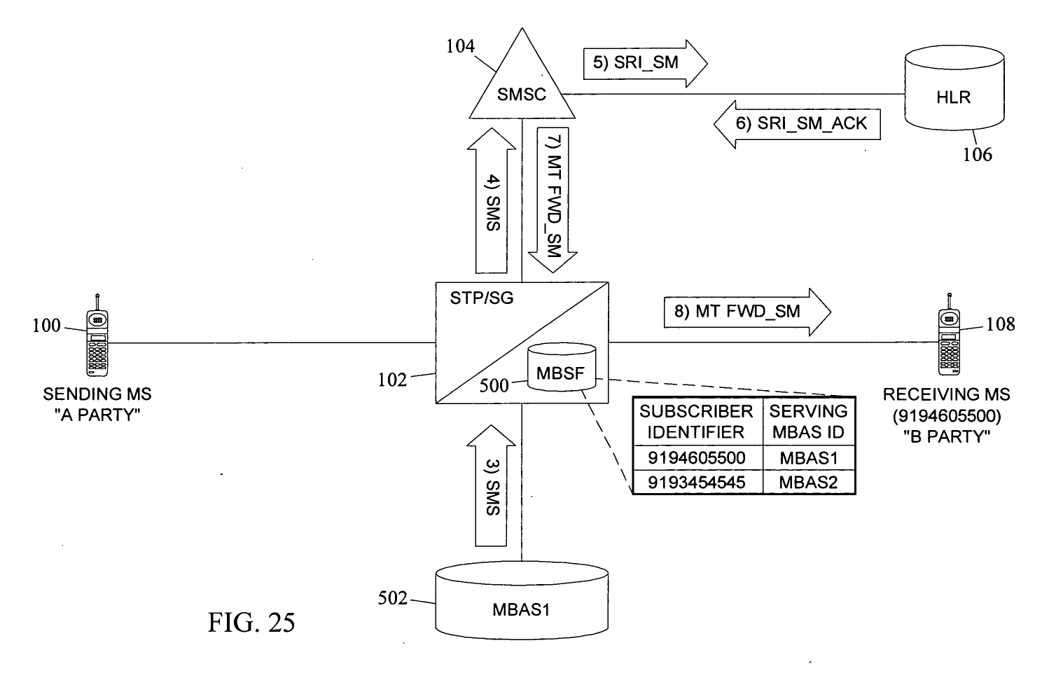

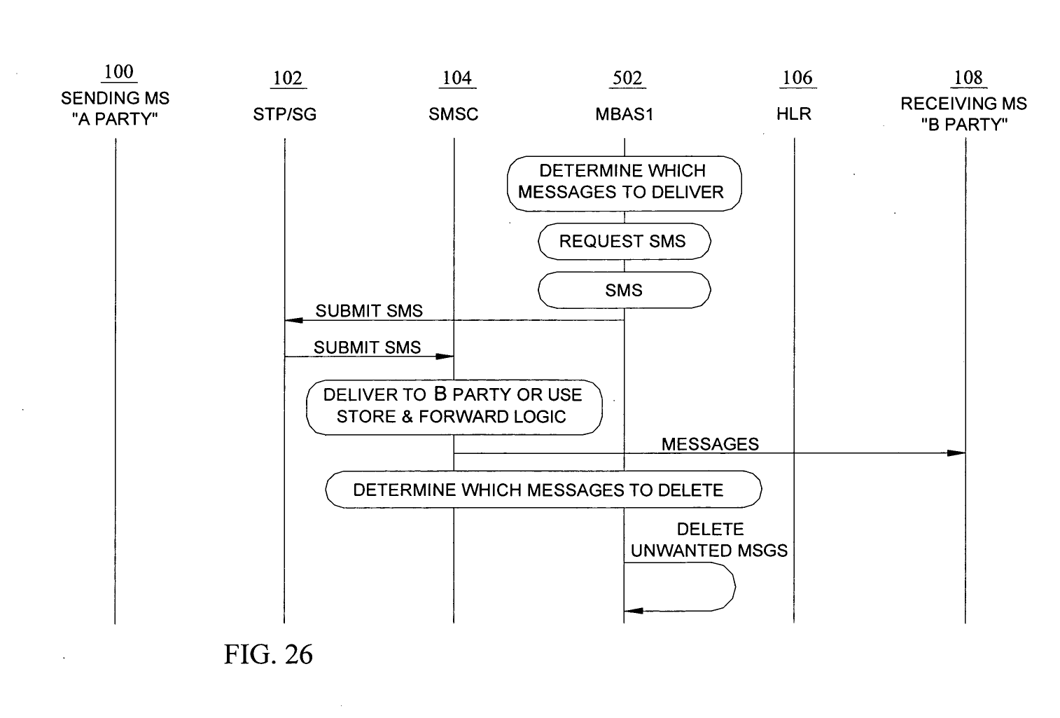

FIGS. 25 and 26 are a diagram and a call flow of an exemplary network for providing subscriber-controlled message service message delivery using a dynamic mailbox service, where the dynamic mailbox processes a selection of messages from the subscriber according to an embodiment of the subject matter described herein. Processing the stored messages based on the selection input received from B Party 108 may include, for example, delivering a first set of messages to B Party 108 and deleting a second set of messages from mailbox storage. The determination made by MBAS 502 may be made by parsing the short code message and thus depend on the particular handset editing method implemented by the network operator. In FIG. 25, the short code message has been received by MBAS 502 as described above and, based on that message, MBAS 502 then requests a first set of messages from message storage 110. The messages retrieved from message storage 110 are then forwarded to SMSC 104 for delivery according to conventional methods except that SMSC 104 must include additional logic necessary to recognize that the messages in the scenario illustrated in FIG. 25 are sent by MBAS 502, rather than A Party 100, and therefore must not be sent back to MBAS 502, as this would create an infinite loop. Thus, SMSC 104 must recognize that this is a resubmitted message and deliver it conventionally, including applying store-and-forward logic if B Party 108 is not available. Continuing the example illustrated in FIG. 25, after delivering the first set of selected messages to B Party 108, MBAS 502 may delete the second set of messages from message storage 110. However, it is appreciated that other operations may be performed on these unwanted messages, such as providing a notification to the sending party or a separate third party, without departing from the subject matter described herein.

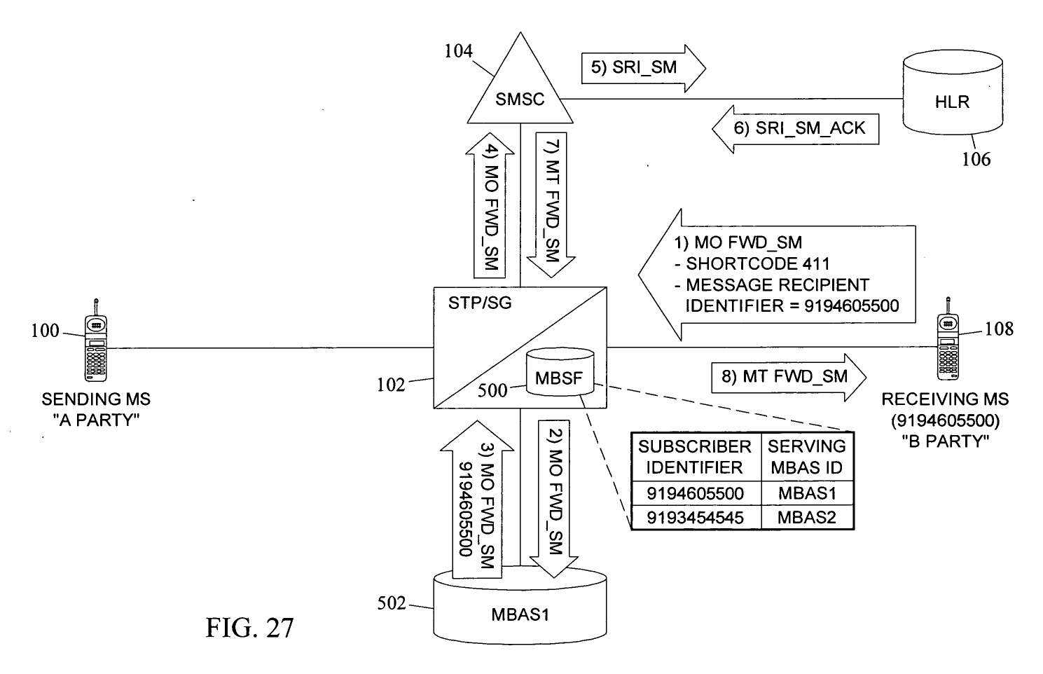

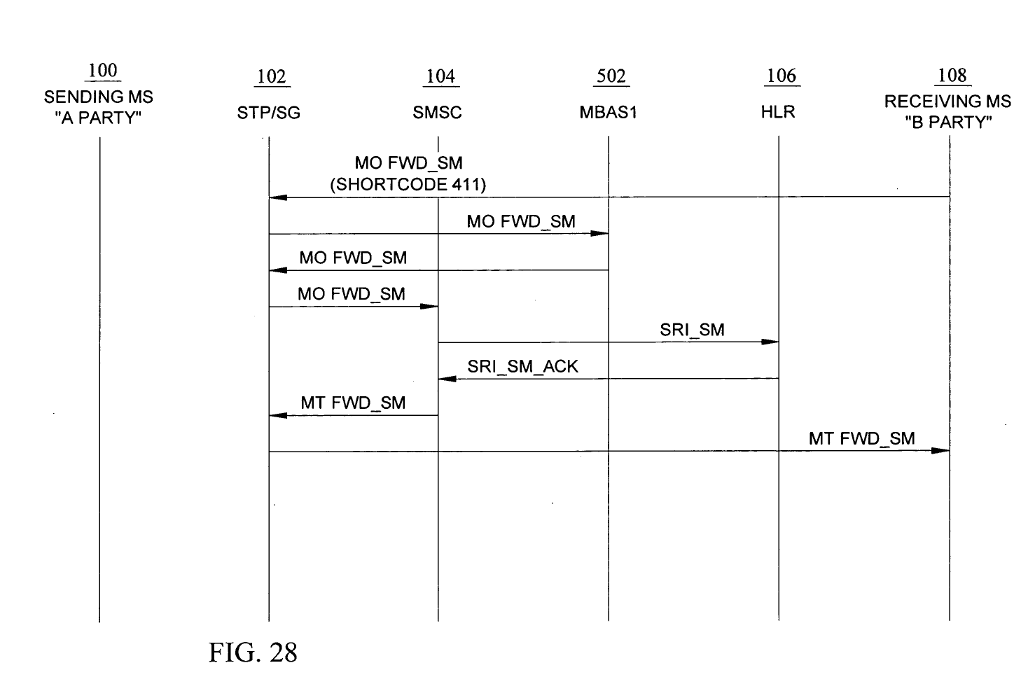

FIGS. 27 and 28 are a diagram and a call flow of an exemplary network for providing subscriber-controlled message service message delivery using a dynamic mailbox service, where the subscriber initiates the selection of messages to be sent to the subscriber according to an embodiment of the subject matter described herein. FIGS. 27 and 28 illustrate the first of two potential “pull” embodiments whereby B Party 108 initiates the retrieval of a list of messages stored by MBAS 502 for selection as to whether they should be received or blocked. In FIG. 27, B Party 108 generates and sends MO_FWD_SM message including short code 411 to node 102 that includes a request for a listing of undelivered messages associated with the subscriber that have been stored by the dynamic mailbox service. Upon receiving the message, MBSF 500 located at node 102 performs a lookup to determine how to route the message. In the example illustrated, a lookup for the subscriber identifier 9194605500 included in the message results in a matching entry indicating that the message should be routed to MBAS 502. Upon receiving the message, MBAS 502 generates a MO_FWD_SM message including a list of the requested messages and sends it to SMSC 104 for delivery. Using conventional methods, SMSC 104 delivers the message list message to B Party 108 so that B Party 108 may input his selection.

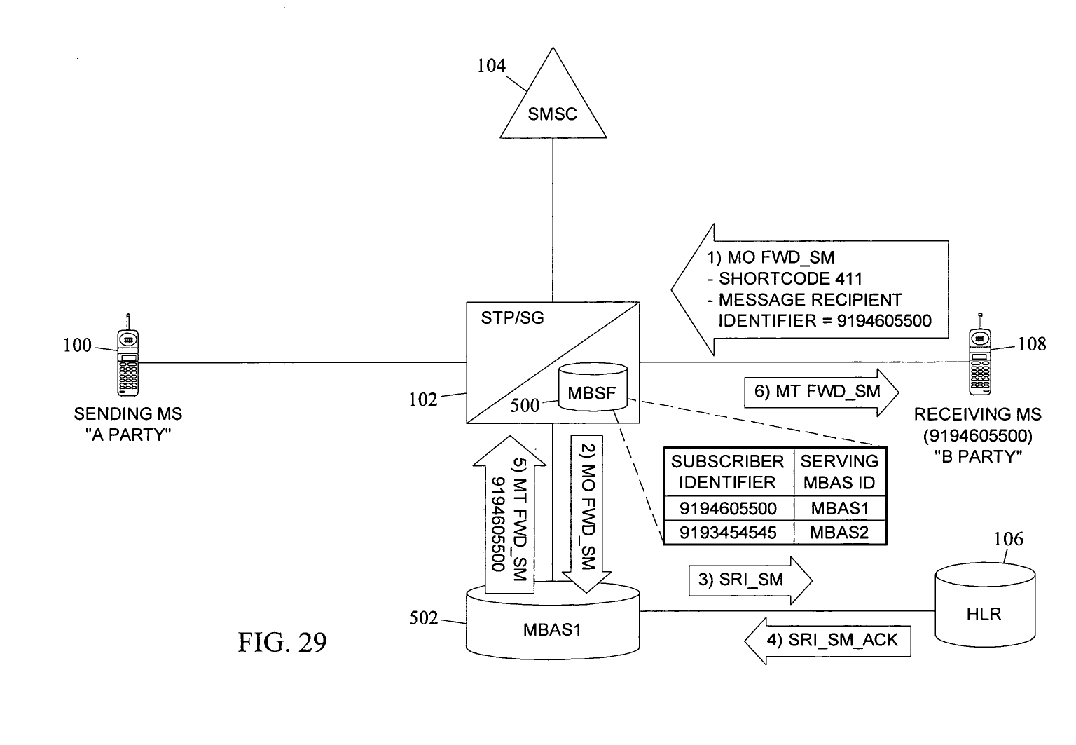

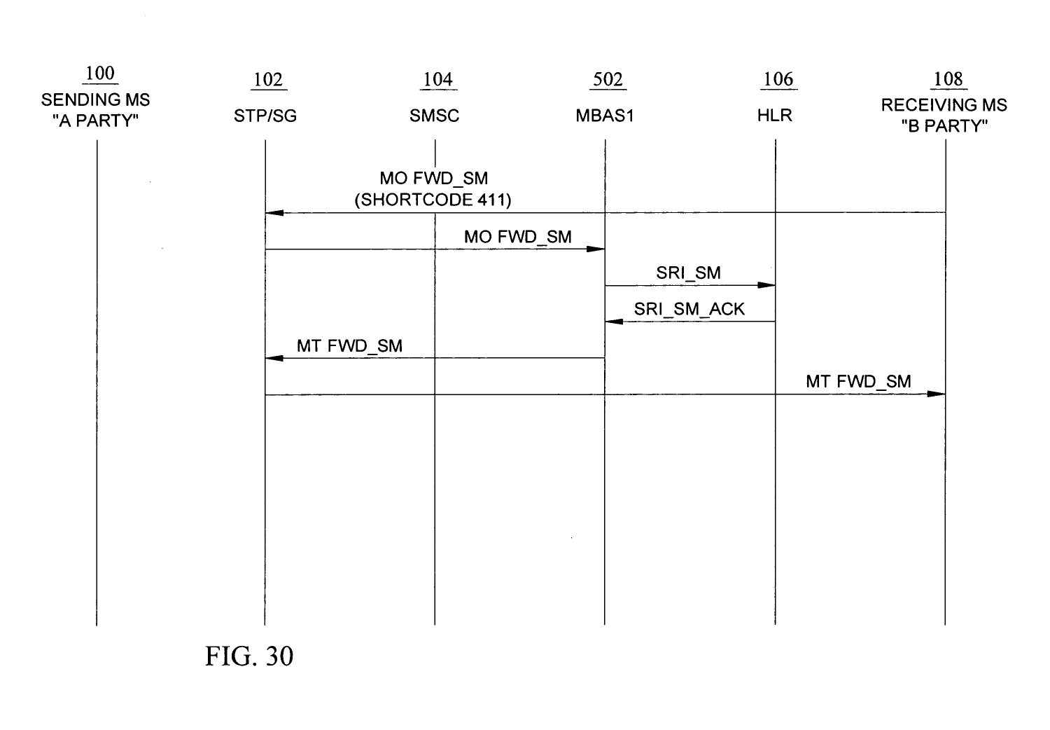

FIGS. 29 and 30 are a diagram and a call flow of an exemplary network for providing subscriber-controlled message service message delivery using a dynamic mailbox service, where the subscriber initiates the selection of messages to be sent to the subscriber without utilizing a short message service center according to an embodiment of the subject matter described herein. The embodiment shown in FIG. 29 performs the same function as the embodiment shown in FIG. 27, but by connecting HLR 106 to MBAS 502, SMSC 104 is shielded from processing any messages associated with receiving or responding to the query message generated by B Party 108. This embodiment may advantageously reduce the message processing load on SMSC 104, however other embodiments may be implemented without departing from the scope of the subject matter described herein.

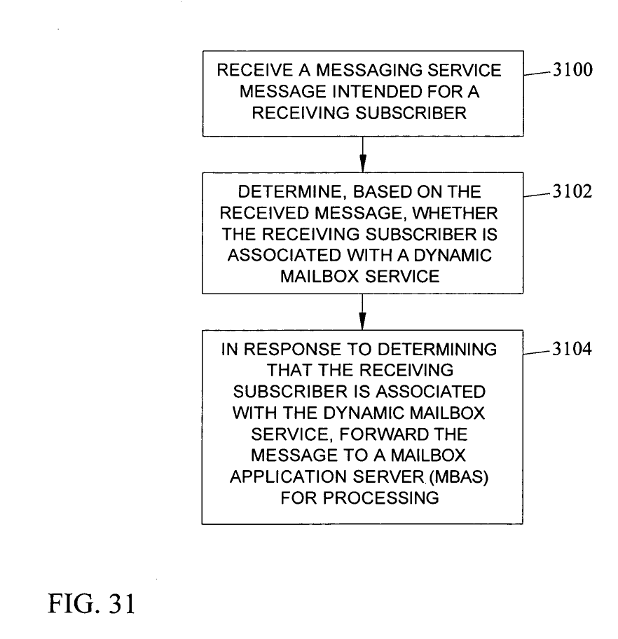

FIG. 31 is a flow chart of a process for providing subscriber-controlled message service message delivery using a dynamic mailbox service according to an embodiment of the subject matter described herein. Referring to FIG. 31, in block 3100, a message service message intended for a subscriber is received. For example, a SMS message intended for B Party 108 may be received by MBSF 500 located on node 102.

In block 3102, it is determined, based on the received message, whether the subscriber is associated with a dynamic mailbox service. For example, a lookup may be performed by MBSF 500 in a database including receiving mobile subscriber IDs and associated dynamic mailbox service status. The called party ID may be extracted from the received message and used to locate a matching entry in the dynamic mailbox user database, where a matching entry indicates the particular MBAS, from among a plurality of possible MBASs, serving the subscriber. Alternately, if no matching entry is found, the subscriber is not a dynamic mailbox service user and the message may be processed according to conventional methods.

In block 3104, in response to determining that the subscriber is associated with the dynamic mailbox service, the message is forwarded to a mailbox application server for processing. As described above, if a matching entry is found by MBSF 500 and the message is routed to MBAS 502, MBAS 502 may process the message. In the event that the subscriber's status is “open,” indicating that he desires messages to be delivered immediately from all sending subscribers, MBAS 502 may attempt immediate delivery of the message to the subscriber. Alternately, the subscriber's status may be “closed,” indicating that messages should not be immediately delivered, but rather should be screened based on one or more user-configurable settings. For example, the subscriber may configure a whitelist containing the subscriber identifiers of those sending subscribers allowed to send messages to the subscriber even when the subscriber status is closed. In addition, a blacklist may be maintained containing a list of subscriber identifiers associated with sending subscribers whose messages are not to be sent to the subscriber. Similar to a blacklist may be an unsolicited commercial message filter (i.e. SPAM filter) containing a list or an algorithm for determining unwanted messages. Parental controls may also be implemented where a third party (i.e. a parent) may be notified upon the reception of a message by a target subscriber (i.e. a child). Moreover, parental controls may provide for third party control over one or more of the above-described lists and filters. For example, parents may place themselves on the child's whitelist, block all unsolicited commercial messages, and receive a notification each time a message is received by the child from one of his or her friends.

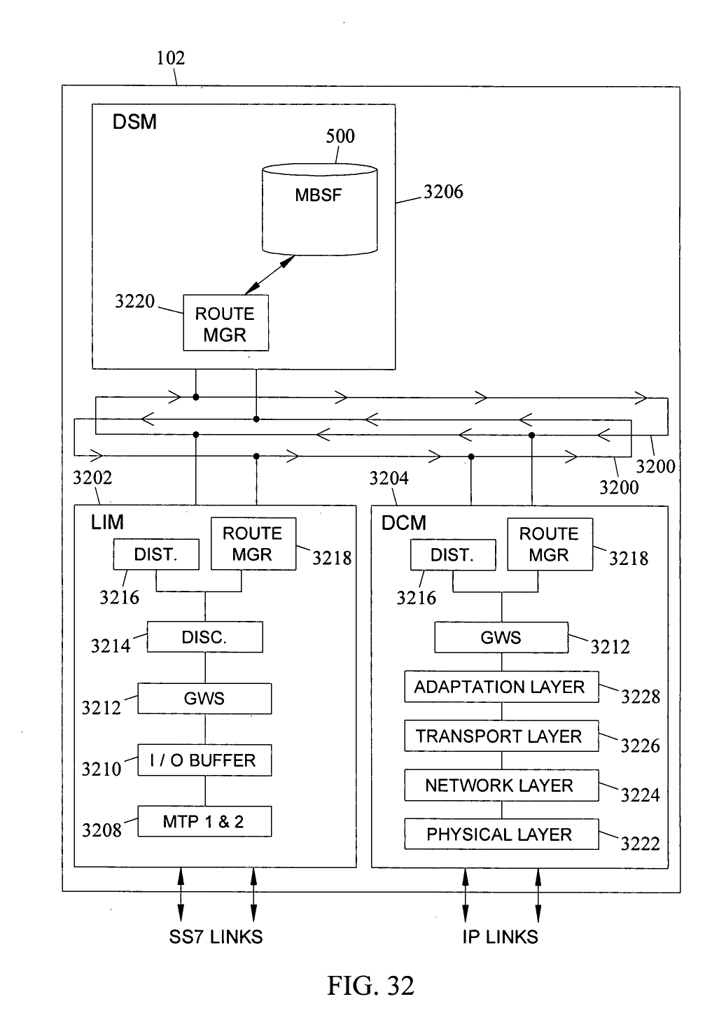

FIG. 32 is a block diagram of an exemplary internal architecture of a network node for providing subscriber-controlled message service message delivery using a dynamic mailbox service according to an embodiment of the subject matter described herein. Referring to FIG. 32, signaling message routing node/signaling gateway 102, such as a signal transfer point (STP), may include an internal communications bus 3200 that includes two counter-rotating serial rings. A number of processing modules or cards may be coupled to bus 3200. In FIG. 32, bus 3200 may be coupled to one or more communications modules, such as a link interface module (LIM) 3202, a data communications module (DCM) 3204, and a database service module (DSM) 3206. These modules are physically connected to bus 3200 such that signaling and other types of messages may be routed internally between active cards or modules. For simplicity of illustration, only a single LIM, a single DCM, and a single DSM cards are included in FIG. 32. However, node 102 may include multiple other LIMs, DCMs, DSMs, and other cards, all of which may be simultaneously connected to and communicating via bus 3200. Each module 3202, 3204, and 3206 may execute the applications or functions that reside on each module and control communication with other modules via bus 3200.

LIM 3202 may include an SS7 MTP level 1 and 2 function 3208, an I/O buffer 3210, a gateway screening (GWS) function 3212, a message discrimination function 3214, a message distribution function 3216, and a route manager 3218. MTP level 1 and 2 function 3208 sends and receives digital data over a particular physical interface, provides error detection, error correction, and sequenced delivery of SS7 message packets. I/O buffer 3210 provides temporary buffering of incoming and outgoing signaling messages.

GWS function 3212 examines received message packets and determines whether the message packets should be allowed into node 102 for processing and/or routing. Discrimination function 3214 performs discrimination operations, which may include determining whether the received message packet requires processing by an internal processing subsystem or is simply to be through switched (i.e., routed on to another node in the network). Messages that are permitted to enter node 102, such as dynamic mailbox service messages, may be routed to other communications modules in the system or distributed to an application engine or processing module via bus 3200.

DSM 3206 may receive dynamic mailbox service messages from LIM 3202 via message distribution function 3216. Distribution function 3216 located on LIM 3202 may forward dynamic mailbox service messages to DSM 3206 via bus 3200. Upon receiving a dynamic mailbox service message, MBSF 3206 may perform a lookup to determine whether to route the message to MBAS 502 for dynamic mailbox service. MBSF 3206 may contain short codes, a whitelist, a blacklist, an unsolicited message filter, subscriber identifiers, MBAS identifiers, and any other information suitable for providing dynamic mailbox service. Upon determining a message is associated with dynamic mailbox service, MBSF 3206 may generate forward the message to DCM 3204 via bus 3200 and route manager 3220.

DCM 3204 includes functionality for sending and receiving SS7 messages over IP signaling links. In the illustrated example, DCM 3204 includes a physical layer function 3222, a network layer function 3224, a transport layer function 3226, an adaptation layer function 3228, and functions 3212, 3216, and 3218 described above with regard to LIM 3202. Physical layer function 3222 performs open systems interconnect (OSI) physical layer operations, such as transmitting messages over an underlying electrical or optical interface. In one example, physical layer function 3222 may be implemented using Ethernet. Network layer function 3224 performs operations, such as routing messages to other network nodes. In one implementation, network layer function 3224 may implement Internet protocol. The transport layer function 3226 implements OSI transport layer operations, such as providing connection oriented transport between network nodes, providing connectionless transport between network nodes, or providing stream oriented transport between network nodes. Transport layer function 3226 may be implemented using any suitable transport layer protocol, such as stream control transmission protocol (SCTP), transmission control protocol (TCP), or user datagram protocol (UDP). Adaptation layer function 3228 performs operations for sending and receiving SS7 messages over IP transport. Adaptation layer function 3228 may be implemented using any suitable IETF or other adaptation layer protocol. Examples of suitable protocols include MTP level 2 peer-to-peer user adaptation layer (M2PA), MTP level 3 user adaptation layer (M3UA), and/or signaling connection control part (SCCP) user adaptation layer (SUA). Functions 3212, 3216, and 3218 perform the same operations as the corresponding components described above with regard to LIM 3202.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing subscriber-controlled message service message delivery using a dynamic mailbox service, the method comprising:
receiving a message service message destined for a subscriber;
forwarding the message service message to a mailbox application server (MBAS) that provides dynamic mailbox service;
at the MBAS, providing the dynamic mailbox service, wherein providing the dynamic mailbox service includes allowing the subscriber to dynamically control delivery of the message service message from the MBAS to the subscriber.

2. The method of claim 1 comprising determining, based on the received message service message, whether the subscriber subscribes to the dynamic mailbox service.

3. The method of claim 2 wherein the determining of whether the subscriber has subscribed to the dynamic mailbox service is performed at a signaling message routing node.

4. The method of claim 2 wherein the determining of whether the subscriber has subscribed to the dynamic mailbox service is performed at a short message service center (SMSC).

5. The method of claim 1 wherein providing subscriber-controlled message service message delivery using a dynamic mailbox service is performed in a manner that bypasses a short message service center (SMSC).

6. The method of claim 1 wherein receiving a message service message includes receiving at least one of a short message service (SMS) message, a multimedia message service (MMS) message, an instant message (IM), and a session initiation protocol (SIP) message.

7. The method of claim 1 wherein allowing the subscriber to dynamically control the delivery of the message service message from the MBAS to the subscriber includes:
sending a list of messages to the subscriber, where the list includes messages stored at the MBAS for the subscriber;
receiving a selection of messages from the subscriber from the list of messages sent to the subscriber; and
processing the messages stored at the MBAS for the subscriber based on the received selection.

8. The method of claim 7 wherein receiving a selection of messages includes receiving one of an indication of messages that the subscriber desires to receive and an indication of messages that the subscriber does not desire to receive.

9. The method of claim 7 wherein receiving a selection of messages from the subscriber includes receiving a short message service (SMS) message including a short code identifying the message as a selection message for dynamic mailbox service.

10. The method of claim 7 wherein processing the messages stored at the MBAS includes at least one of delivering the messages, deleting the messages, redirecting the messages, and generating a notification relating to the delivery status of the messages.

11. The method of claim 7 wherein processing the messages stored at the MBAS includes accessing at least one of a whitelist, a blacklist, an unsolicited message filter, and a parental control filter.

12. A system for providing subscriber-controlled message service message delivery using a dynamic mailbox service, the system comprising:
a mailbox application server (MBAS) for storing message service messages for a subscriber and for allowing the subscriber to control delivery of message service messages to the subscriber; and
a mailbox screening function (MBSF) for receiving a message service message destined for the subscriber and forwarding the message service message to the MBAS that provides the dynamic mailbox service.

13. The system of claim 12 wherein the MBAS is configured to determine, based on the received message service message, whether the subscriber subscribes to the dynamic mailbox service.

14. The system of claim 13 wherein the MBSF is located at a signaling message routing node.

15. The system of claim 13 wherein the MBSF is configured to is located at a short message service center (SMSC).

16. The method of claim 12 wherein providing subscriber-controlled message service message delivery using a dynamic mailbox service is performed in a manner that bypasses a short message service center (SMSC).

17. The system of claim 12 wherein the MBSF is configured to receive a message service message including at least one of a short message service (SMS) message, a multimedia message service (MMS) message, an instant message (IM), and a session initiation protocol (SIP) message.

18. The system of claim 12 wherein the MBAS is configured to:
send a list of messages to the subscriber, where the list includes messages stored at the MBAS for the subscriber;
receive a selection of messages from the subscriber from the list of messages sent to the subscriber; and
process the messages stored at the MBAS for the subscriber based on the received selection.

19. The system of claim 18 wherein the selection of messages received from the subscriber includes a short message service (SMS) message including a short code identifying the message as a selection message for dynamic mailbox service.

20. The system of claim 18 wherein the MBAS is configured to process the messages stored for the subscriber, where processing includes at least one of delivering the messages, deleting the messages, redirecting the messages, and generating a notification.

21. The system of claim 18 wherein the MBAS is configured to process the messages stored for the subscriber, where processing includes accessing at least one of a whitelist, a blacklist, an unsolicited message filter, and a parental control filter based on the selection.

22. A computer program product comprising computer executable instructions embodied in a computer readable medium for performing steps comprising:
receiving a message service message destined for a subscriber;
forwarding the message service message to a mailbox application server (MBAS) that provides dynamic mailbox service; and
at the MBAS, providing the dynamic mailbox service, wherein providing the dynamic mailbox service includes allowing the subscriber to dynamically control delivery of the message service message from the MBAS to the subscriber.
